(19) United States
(12) Patent Application Publication
(10) Pub. No.: US 2014/0089057 A1
(43) Pub. Date: Mar. 27, 2014

(54) Diversity Reporting Tool

(71) Applicants: Henry Roderick Robinson, Mason, OH (US); Andrew T. Johnson, Dayton, OH (US); Susan M. Oswalt, Mason, OH (US); Mark K. Potter, Hamilton, OH (US)

(72) Inventors: Henry Roderick Robinson, Mason, OH (US); Andrew T. Johnson, Dayton, OH (US); Susan M. Oswalt, Mason, OH (US); Mark K. Potter, Hamilton, OH (US)

(73) Assignee: CONNXUS, INC., Mason, OH (US)

(21) Appl. No.: 14/039,960

(22) Filed: Sep. 27, 2013

Related U.S. Application Data
(60) Provisional application No. 61/706,386, filed on Sep. 27, 2012.

(51) Int. Cl. G06Q 10/06

(52) U.S. Cl. CPC G06Q 10/0637
USPC 705/7.36

(57) ABSTRACT

Included are embodiments for diversity reporting. Some embodiments include providing a first user interface to a buyer, where the first user interface includes an option to request a report of diversity spend data from a plurality of prime suppliers, receiving a report request to provide a report of the diversity spend data to the buyer and providing a second user interface to the at least one prime supplier that includes a data request for the diversity spend data. Some embodiments include receiving the diversity spend data from the at least one prime supplier, where the diversity spend data that was received includes data regarding an amount spent with a diverse vendor over a predetermined length of time and providing the report of the diversity spend data to the buyer.

### CROSS REFERENCE

This application claims priority to U.S. Provisional Application No. 61/706,386 filed Sep. 27, 2012 and entitled Tier-2 Reporting Tool, which is hereby incorporated by reference in its entirety.

### BACKGROUND

1. Field

Embodiments provided herein generally relate a diversity reporting tool and particularly to a cloud-based system that reports tier-2 supplier diversity as a function of spending.

2. Technical Background

Currently, many companies are striving to achieve greater diversity among their employees. This quest for diversity may include employing a diverse workforce and contracting with diverse suppliers. However, oftentimes the suppliers (tier 1 suppliers) with whom the company contracts may subcontract their tasks to other suppliers (tier-2 suppliers). As such, the company may not know whether these other suppliers are diverse and thus whether the target diversity is achieved.

### SUMMARY

Included are embodiments for diversity reporting. Some embodiments include providing a first user interface to a buyer, where the first user interface includes an option to request a report of diversity spend data from a plurality of prime suppliers, receiving a report request to provide a report of the diversity spend data to the buyer, where the report request includes a predetermined timeframe for the report and at least one of the plurality of prime suppliers that is assigned to the report, and providing a second user interface to the at least one prime supplier that includes a data request for the diversity spend data. Some embodiments include receiving the diversity spend data from the at least one prime supplier, where the diversity spend data that was received includes data regarding an amount spent with a diverse vendor over a predetermined length of time and providing the report of the diversity spend data to the buyer.

Also included are embodiments of a diversity reporting tool. Such embodiments include a memory component that stores logic that, when executed by a computing device, causes the computing device to receive a report request to provide a report of diversity spend data to a buyer, where the report request includes a predetermined timeframe for the report and a prime supplier that is assigned to the report and provide a user interface to the prime supplier that includes a data request for the diversity spend data. In some embodiments, the logic causes the computing device to receive the diversity spend data from the prime supplier, where the diversity spend data that was received includes data regarding an amount spent with a diverse vendor over a predetermined length of time and provide a report of the diversity spend data to the buyer.

Also included are embodiments of a system that includes a remote computing device that includes a memory component that stores logic that, when executed by the remote computing device, causes the remote computing device to provide a first user interface to a buyer, where the first user interface includes an option to request a report of diversity spend data from a plurality of prime suppliers, receive a report request to provide a report of the diversity spend data to the buyer, where the report request includes a predetermined timeframe for the report and at least one of the plurality of prime suppliers that is assigned to the report, and provide a second user interface to the at least one prime supplier that includes a data request for the diversity spend data. In some embodiments, the logic causes the remote computing device to receive the diversity spend data from the at least one prime supplier, where the diversity spend data that was received includes data regarding an amount spent with a diverse vendor over a predetermined length of time and provide the report of the diversity spend data to the buyer.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment for providing a tier-2 diversity reporting tool, according to one or more embodiments shown and described herein;

FIG. 2 depicts a remote computing device for providing the tier-2 diversity reporting tool, according to one or more embodiments shown and described herein;

FIG. 3 depicts a user interface for a buyer to create a report and manage primes, according to one or more embodiments shown and described herein;

FIG. 4 depicts a user interface for viewing a list of one or more primes who have accepted an invitation to report tier-2 spending, according to one or more embodiments shown and described herein;

FIG. 5 depicts a user interface for inviting additional primes to report tier-2 spending, according to one or more embodiments shown and described herein;

FIG. 6 depicts a user interface for granting access to a prime, according to one or more embodiments shown and described herein;

FIG. 7 depicts a user interface for setting up a new report of tier-2 spending, according to one or more embodiments shown and described herein;

FIG. 8 depicts a user interface for viewing and editing reporting periods for tier-2 spending, according to one or more embodiments shown and described herein;

FIG. 9 depicts a user interface for adding an additional reporting period for tier-2 spending, according to one or more embodiments shown and described herein;

FIG. 10 depicts a user interface for deleting a reporting period for tier-2 spending, according to one or more embodiments shown and described herein;

FIG. 11 depicts a user interface for setting up reporting jurisdictions of tier-2 reporting, according to one or more embodiments shown and described herein;

FIG. 12 depicts a user interface for adding an additional reporting jurisdiction for tier-2 spending, according to one or more embodiments shown and described herein;

FIG. 13 depicts a user interface for deleting a reporting jurisdiction for tier-2 spending, according to one or more embodiments shown and described herein;

FIG. 14 depicts a user interface for activating a report of tier-2 spending, according to one or more embodiments shown and described herein;

FIG. 15 depicts a user interface for deleting a report, according to one or more embodiments shown and described herein;

FIG. 16 depicts a user interface for finalizing a report, according to one or more embodiments shown and described herein;

FIG. 17 depicts a user interface for providing a tier-2 report, according to one or more embodiments shown and described herein;

FIG. 18 depicts a first quarter tier-2 report, according to one or more embodiments shown and described herein;

FIG. 19 depicts user interface for providing a first quarter summary report of direct spending and indirect spending, according to one or more embodiments shown and described herein;

FIG. 20 depicts a user interface for a prime to add tier-2 suppliers to the prime account, according to one or more embodiments shown and described herein;

FIG. 21 depicts a user interface for providing a prime with a list of reports setup by a buyer of the prime, according to one or more embodiments shown and described herein;

FIG. 22 depicts a user interface for providing a tier-2 submission for a report, according to one or more embodiments shown and described herein;

FIG. 23 depicts a user interface for a prime to submit a draft report of tier-2 diversity spending, according to one or more embodiments shown and described herein;

FIG. 24 depicts a user interface for viewing and editing direct expenditures by a prime, according to one or more embodiments shown and described herein;

FIG. 25 depicts a user interface for a prime to add a direct expenditure, according to one or more embodiments shown and described herein;

FIG. 26 depicts a user interface for a prime to delete a direct expenditure, according to one or more embodiments shown and described herein;

FIG. 27 depicts a user interface for a prime to view and submit a report to a buyer, according to one or more embodiments shown and described herein;

FIG. 28 depicts a user interface for a prime to view a quarterly summary report for a buyer, according to one or more embodiments shown and described herein;

FIG. 29 depicts a flowchart for a buyer to create and view reports of tier-2 spending, according to one or more embodiments shown and described herein;

FIG. 30 depicts a flowchart for a prime to provide expenditures for tier-2 spending, according to one or more embodiments shown and described herein; and

FIG. 31 depicts a flowchart for providing diversity data, according to embodiments disclosed herein.

### DETAILED DESCRIPTION

Embodiments disclosed herein may be configured for buying companies (buyers) to easily track their tier-2 spending with diverse suppliers. Specifically, the embodiments may be configured as a web (cloud) based, interactive platform that is designed around “ease of use.” The buyer creates an online account and invites their tier-1 suppliers (“primes” or “prime suppliers”) to create their own accounts. The buyer account is linked to the prime accounts, which allows at least one prime supplier to enter sales data and other diversity spend data relative to the buyer. Embodiments disclosed herein track both direct and indirect spending. The buyer can create a variety of custom reports and download to local storage, as desired. Embodiments disclosed herein are “community based” in that each prime and buyer only creates one account, but either can report data to or request data from any prime or buyer in the community.

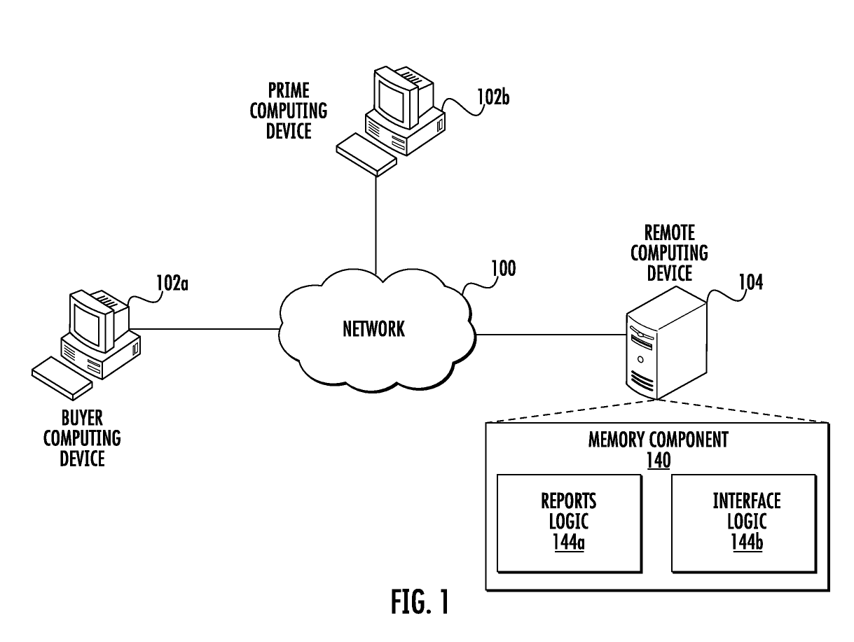

Referring now to the drawings, FIG. 1 depicts a computing environment for providing a tier-2 reporting tool, according to one or more embodiments shown and described herein. As illustrated, a network 100 may be coupled to a buyer computing device 102a, a prime computing device 102b, and a remote computing device 104. The network 100 may include any wide area and/or local area network, such as the internet, a mobile communications network, a satellite network, a public service telephone network (PSTN) and/or other network for facilitating communication between devices. If the network 100 includes a local area network, the local area network may be configured as a corporate network, school network, and/or other open or closed network that is coupled to a wide area network.

Accordingly, the buyer computing device 102a and the prime computing device 102b may each be configured as a personal computer, laptop computer, tablet, mobile computing device, mobile communications device, database, and/or other computing device operated by a buyer and/or vendor, respectively.

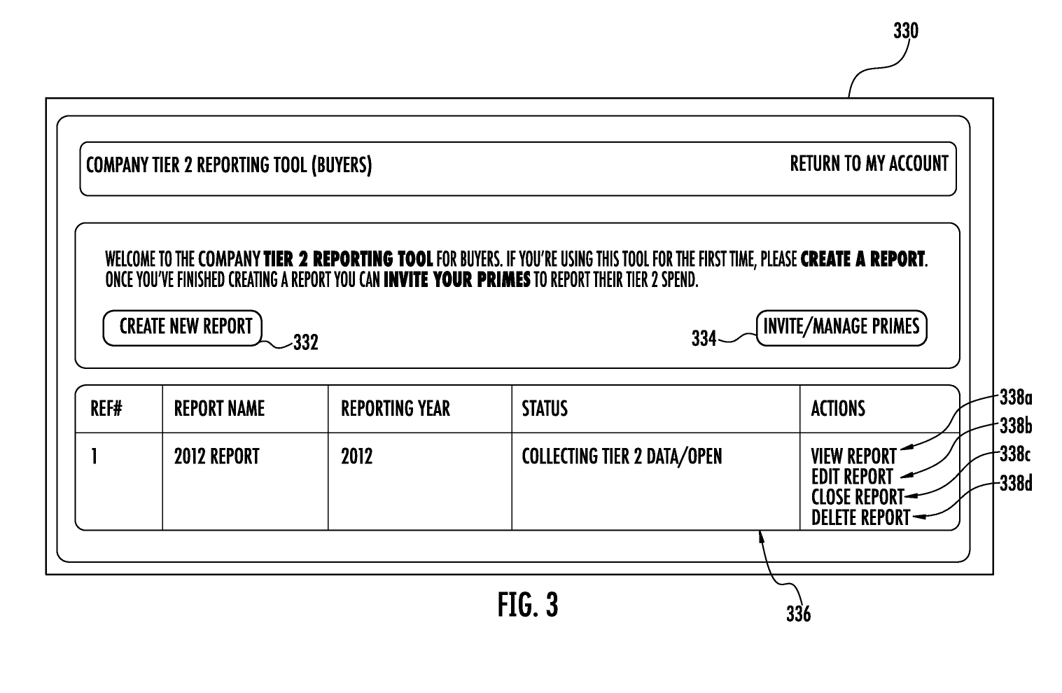

The remote computing device 104 may be configured to generate reports according to the data provided by the buyer and prime and provide user interfaces, such as those depicted in FIGS. 3-28. The remote computing device 104 may be configured as any type of computing device that is designed and operates to operate with the described functionality. Accordingly, the remote computing device 104 includes a memory component 140, which stores reports logic 144a and interface logic 144b. The reports logic 144a may be configured to receive data from the buyer and the prime and generate reports regarding tier-2 spending. The interface logic 144b may cause the buyer computing device 102a and/or the prime computing device 102b to provide one or more user interfaces, such as those depicted in FIGS. 3-28.

It should be understood that while the buyer computing device 102a and the prime computing device 102b are depicted as single personal computers and the remote computing device 104 is depicted as a single server, these are merely examples. Any of these devices may include one or more personal computers, servers, laptops, tablets, mobile computing devices, data storage devices, etc. that are configured for providing information to a user as described herein.

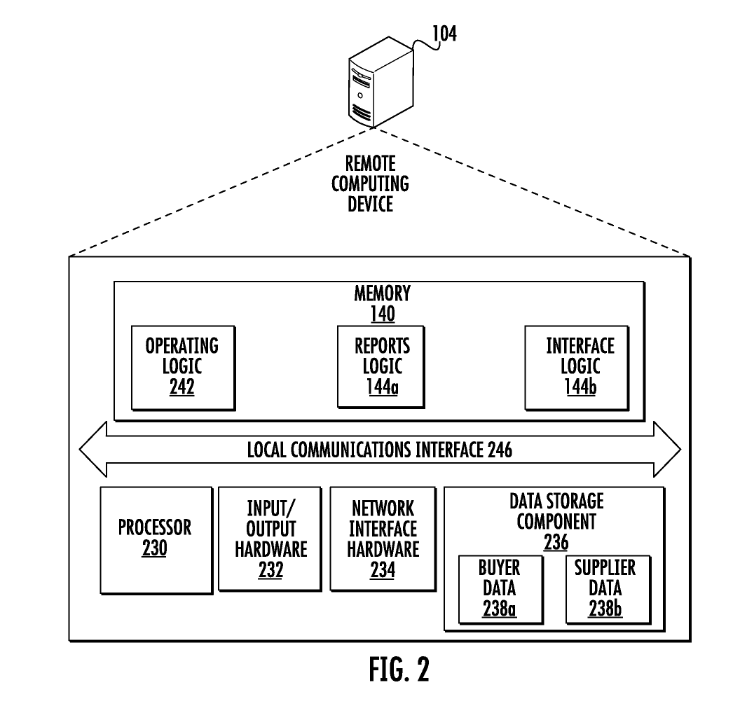

FIG. 2 depicts a remote computing device 104 for providing the tier-2 reporting tool, according to one or more embodiments shown and described herein. In the illustrated embodiment, the remote computing device 104 includes a processor 230, input/output hardware 232, network interface hardware 234, a data storage component 236 (which stores buyer data 238a and supplier data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, the non-transitory computer-readable medium may reside within the remote computing device 104 and/or external to the remote computing device 104.

Additionally, the memory component 140 may be configured to store operating logic 242, the reports logic 144a, and the interface logic 144b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

Similarly, it should be understood that the data storage component 236 may reside local to and/or remote from the remote computing device 104 and may be configured to store one or more pieces of data for access by the remote computing device 104 and/or other components. In some embodiments, the data storage component 236 may be located remotely from the remote computing device 104 and thus accessible via the network 100. In some embodiments however, the data storage component 236 may merely be a peripheral device, but external to the remote computing device 104.

Included in the memory component 140 are the operating logic 242, the reports logic 144a, and the interface logic 144b. The operating logic 242 may include an operating system and/or other software for managing components of the remote computing device 104. Similarly, the reports logic 144a may be configured to receive data from the buyer and prime and generate one or more tier-2 supplier spending reports. The interface logic 144b may cause the remote computing device 104 to provide the user interfaces, as well as receive and respond to inputs from the user.

It should be understood that the components illustrated in FIG. 2 are merely exemplary and are not intended to limit the scope of this disclosure. While the components in FIG. 2 are illustrated as residing within the remote computing device 104, this is merely an example. In some embodiments, one or more of the components may reside external to the remote computing device 104.

FIG. 3 depicts a user interface 330 for a buyer to create a report and manage primes, according to one or more embodiments shown and described herein. As illustrated, the user interface 330 of FIG. 3 includes a create new report option 332 and an invite/manage primes option 334. In response to selection of the create new report option 332, options for creating tier-2 reporting may be provided. As an example, the user may access information of previously subscribed primes to generate a new report. The information may include updated information from the most previous report and/or may utilize different information from previous reports. In response to selection of the invite/manage primes option 334, one or more additional options may be provided for inviting new primes to participate in reporting and/or for managing currently subscribed primes.

The user interface 330 also includes a reporting area 336, which provides information regarding previously created reports. As illustrated, the “2012 report” is related to the reporting year of 2012 and is currently open. Additional options 338a, 338b, 338c, and 338d are also provided for viewing the report, editing the report, deleting the report, and/or closing the report, as described in more detail below.

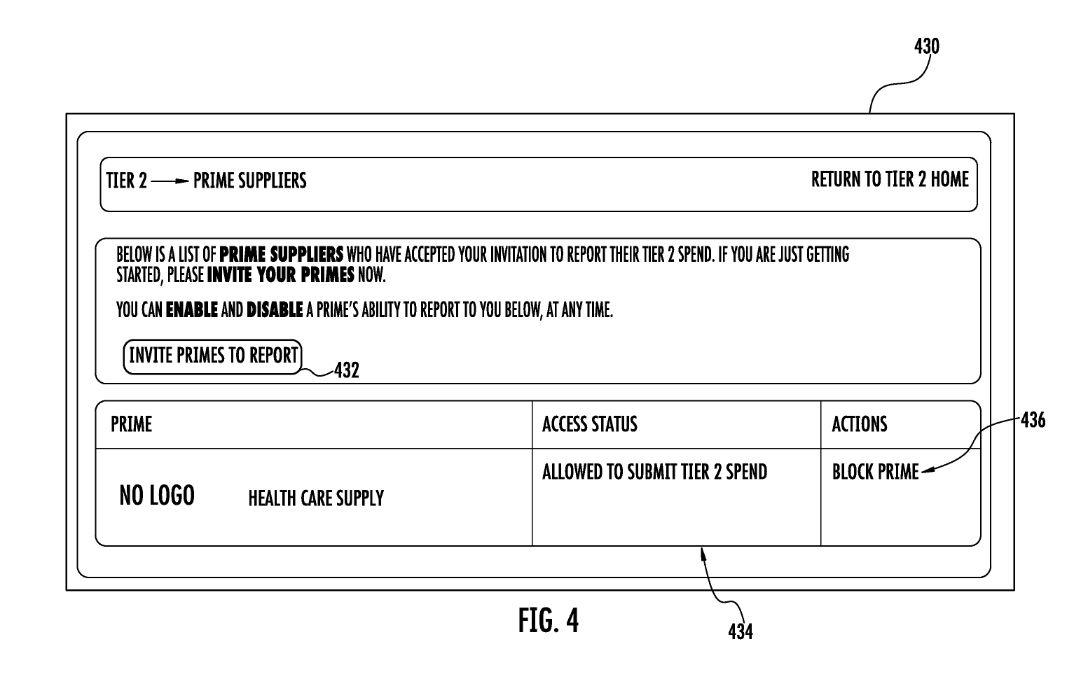

FIG. 4 depicts a user interface 430 for viewing a list of one or more primes who have accepted an invitation to report tier-2 spending, according to one or more embodiments shown and described herein. As illustrated, the user interface 430 includes an invite primes option 432, as well as a prime status section 434. In response to selection of the invite primes option 432, the user may be provided with one or more additional options for identifying the primes that the user wishes to invite. As an example, if the user wishes to purchase from a vendor, but wants to first determine the diversity that that vendor currently employs, the user can select the invite primes option 432 and then identify that vendor. The vendor may then be provided with options for sending the requested diversity data to the remote computing device 104. The remote computing device 104 may then perform analysis and/or create reports, based on that data and user commands.

Similarly, the prime status section 434 includes a listing of those primes that have accepted invitations to report tier-2 spend. Accordingly, the prime status section 434 may include a prime name and a prime access status. Also included is a block prime option 436 for blocking a prime from reporting tier-2 spend (and/or other information). As an example, if the user determines that a particular prime will not be a vendor of the user, the user may wish to not view information from that prime. As such, the user may select the block prime option 436 to refrain from receiving such information.

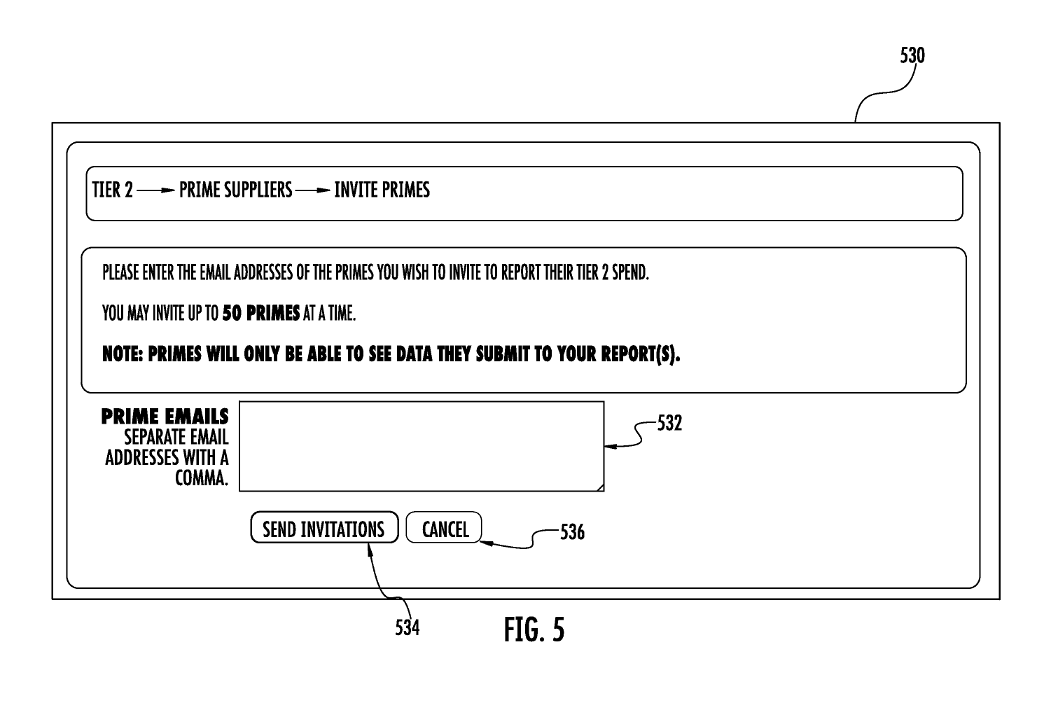

FIG. 5 depicts a user interface 530 for inviting additional primes to report tier-2 spending, according to one or more embodiments shown and described herein. In response to selection of the invite primes option 432 from FIG. 4, the user interface 530 may be provided, which includes a text prompt 532, as well as a send invitations option 534 and a cancel option 536. Specifically, the user may identify email addresses (and/or other identifiers) of primes that the user would like to report diversity and/or other tier-2 type data. Upon populating the text prompt 532, the user may select the send invitations option 534 for sending invitations to the identified primes. In response to selection of the cancel option 536, the user may be returned to the user interface 430 from FIG. 4.

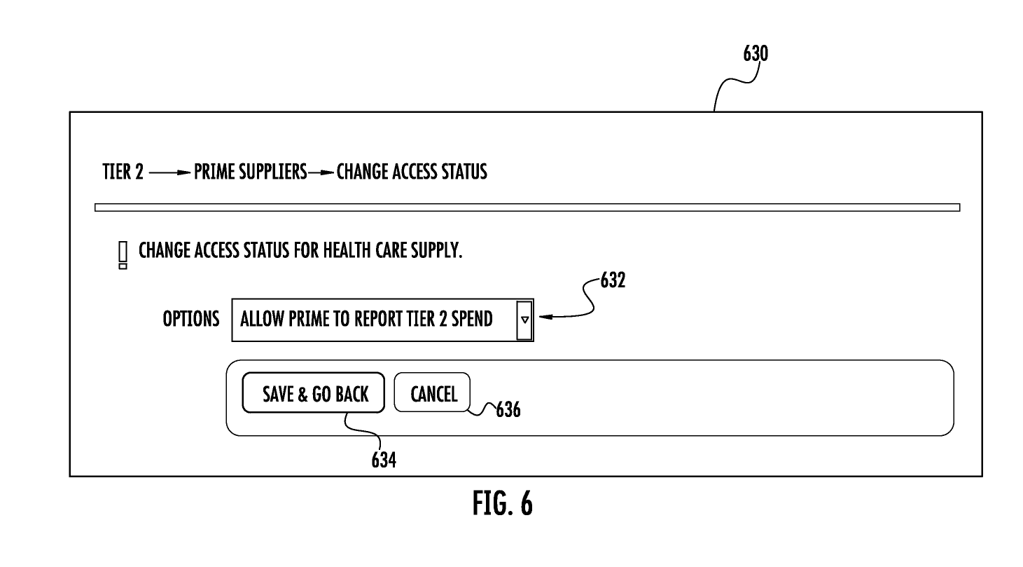

FIG. 6 depicts a user interface 630 for granting access to a prime, according to one or more embodiments shown and described herein. As illustrated, the user interface 630 may be provided in response to selection of the block prime option 436 from FIG. 4 and includes status change option 632, as well as a save option 634 and a cancel option 636. Specifically, the status change option 632 may provide sub-options such as blocking the prime, allowing the prime to report tier-2 spend, allowing the prime to only report a subset of tier-2 spend, etc. Upon selecting the desired sub-option from the status change option 632, the user may select the save option 634 for saving the selection or the cancel option 636 for not changing the status of the prime.

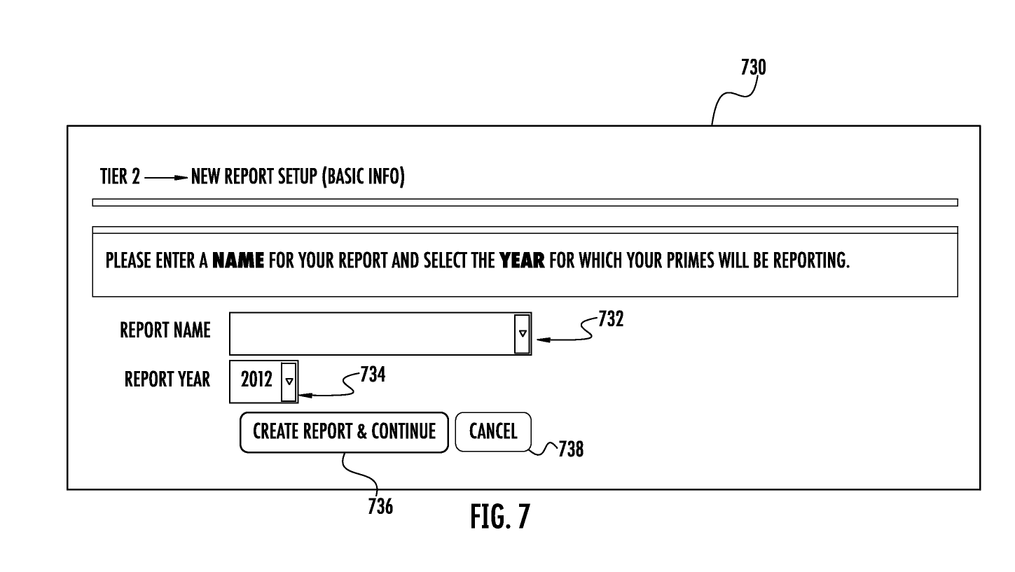

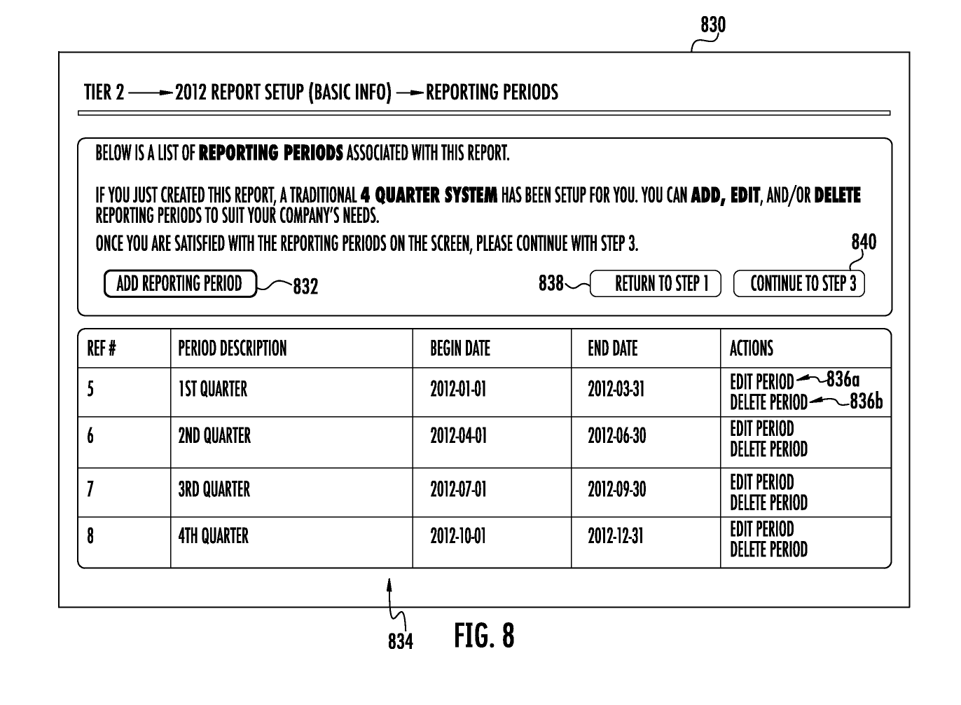

FIG. 7 depicts a user interface 730 for setting up a new report of tier-2 spending, according to one or more embodiments shown and described herein. In response to selection of the create new report option 332 from FIG. 3, the user interface 730 may be provided. The user interface 730 includes a report name field 732, a report year field 734, a create report option 736 and a cancel option 738. Accordingly, if the user wishes to create a new report, the user may input the desired report name into the report name field 732. The user may select a reporting year in the report year field 734. The user may then select the create report option 736 for creating the report and proceeding to the user interface 830 of FIG. 8. In response to selection of the cancel option 738 the report will not be created.

FIG. 8 depicts a user interface 830 for viewing and editing reporting periods for tier-2 spending, according to one or more embodiments shown and described herein. In response to selection of the create report option 736 from FIG. 7, the user interface 830 may be provided. As illustrated, the user interface 830 includes an add reporting period option 832 for adding a reporting period for this newly created report, as well as a period listing area 834, a return option 836, and a proceed option 840. As an example, the user may wish for annual reporting, semi-annual reporting, quarterly reporting, monthly reporting, weekly reporting, and/or other temporal and/or benchmark reporting periods. Examples of benchmark periods may include reporting when diversity spending reaches a particular threshold and/or other diversity thresholds that are reached.

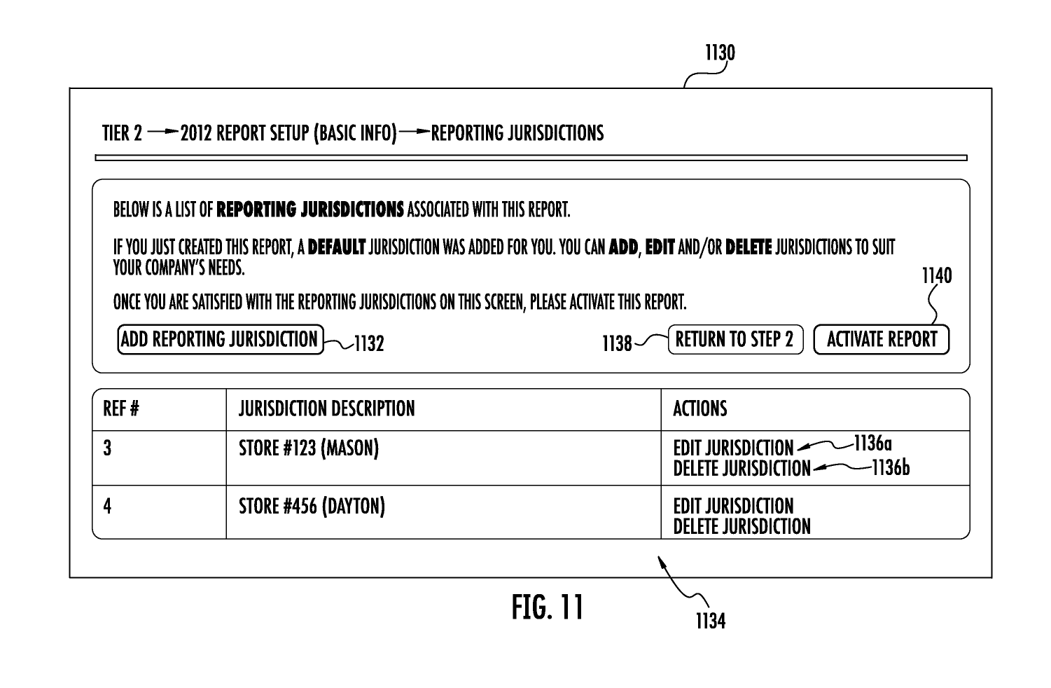

Accordingly, the period listing area 834 provides previously added periods for the new report, as well as a period description, a begin date, an end date and one or more actions that may be performed for the reporting period. As an example, the actions may include an edit period option 836a for editing one or more pieces of information related to the reporting period and a delete period option 836b for deleting the period. In response to selection of the return option 838, the remote computing device 104 may return the user to a previous user interface. In response to selection of the proceed option 840, the user interface 1130 of FIG. 11 may be provided.

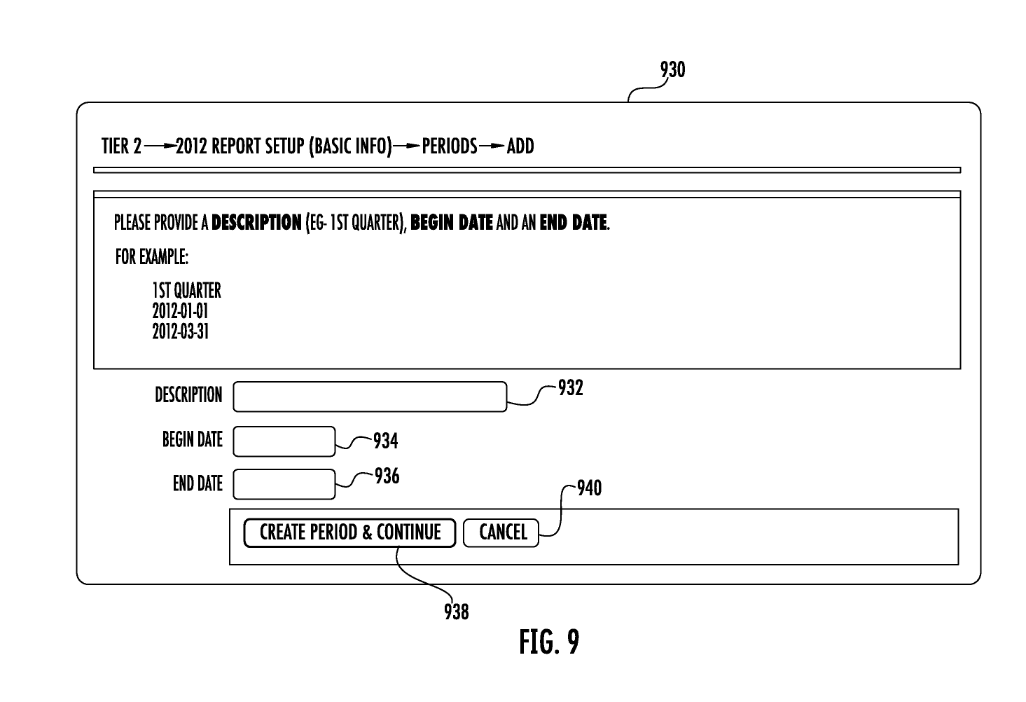

FIG. 9 depicts a user interface 930 for adding an additional reporting period for tier-2 spending, according to one or more embodiments shown and described herein. In response to selection of the add reporting period option 832 from FIG. 8, the user interface 930 may be provided. As illustrated, the user interface 930 includes a description field 932, a begin date field 934, an end date field 936, a create period option 938, and a cancel option 940. The user may populate the description field 932 with a user-defined description. Similarly, the user may provide a begin date in the begin date field 934 and an end data in the end date field 936. Once the user has input the desired information, the user may select the create period option 938. If the user wishes to not create this period, the user may select the cancel option 940.

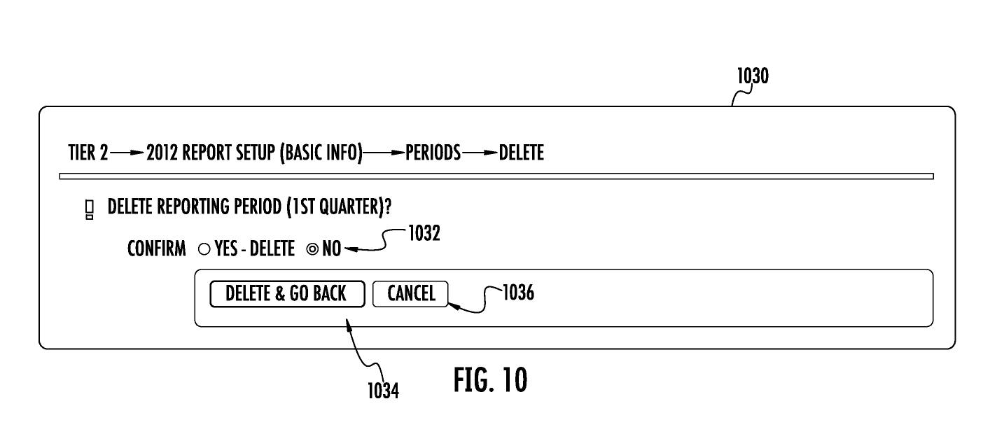

FIG. 10 depicts a user interface 1030 for deleting a reporting period for tier-2 spending, according to one or more embodiments shown and described herein. In response to selection of the delete period option 836b from FIG. 8, the user interface 1030 may be provided. As illustrated, the user interface 1030 includes a confirm field option 1032, a delete option 1034, and a cancel option 1036. Specifically, if the user wishes to delete a reporting period, the user selects the appropriate delete period option 836b from FIG. 8 and confirms that deletion via the confirm field option 1032. The user may then select the delete option 1034 of permanent deletion.

FIG. 11 depicts a user interface 1130 for setting up reporting jurisdictions of tier-2 reporting, according to one or more embodiments shown and described herein. In response to selection of the proceed option 840 from FIG. 8, the user interface 1130 may be provided. As illustrated, the user interface 1130 includes an add reporting jurisdiction option 1132, a reporting jurisdictions area 1134, a return option 1138, and an activate report option 1140. The add reporting jurisdiction option 1132 may be configured for the user to add a reporting jurisdiction. As an example, if the user wishes the report to only contain information regarding a particular branch, store, geographic area, and/or other subset of a prime, the user may so select these criteria. In this vein, the reporting jurisdictions area 1134 may provide default jurisdictions as selected by the remote computing device 104 and/or jurisdictions that the user has created. Also included in the reporting jurisdictions area 1134 are an edit jurisdiction option 1136a and a delete jurisdiction option 1136b for editing and deleting a jurisdiction, respectively. In response to selection of the return option 1138, the remote computing device 104 may return the user to the user interface 1030 from FIG. 10. In response to selection of the activate report option 1140, the new report may be activated.

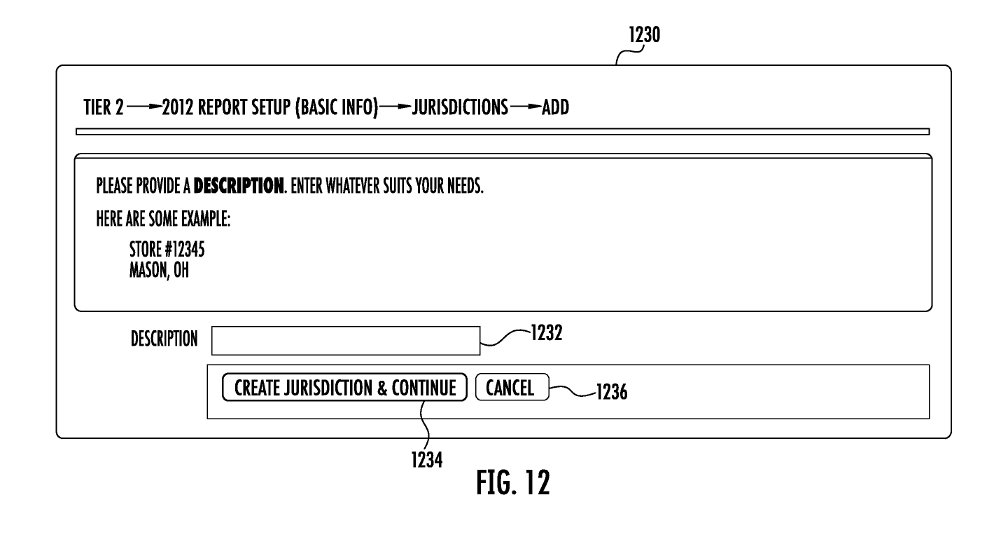

FIG. 12 depicts a user interface 1230 for adding an additional reporting jurisdiction for tier-2 spending, according to one or more embodiments shown and described herein. In response to selection of the add reporting jurisdiction option 1132 from FIG. 11, the user interface 1230 may be provided. As illustrated, the user interface 1230 includes a description field 1232, a create jurisdiction option 1234, and a cancel option 1236. The user may populate the description field 1232 with an appropriate description of the jurisdiction and may then select the create jurisdiction option 1234 for creating the jurisdiction. The user may select the cancel option 1236 for canceling this action.

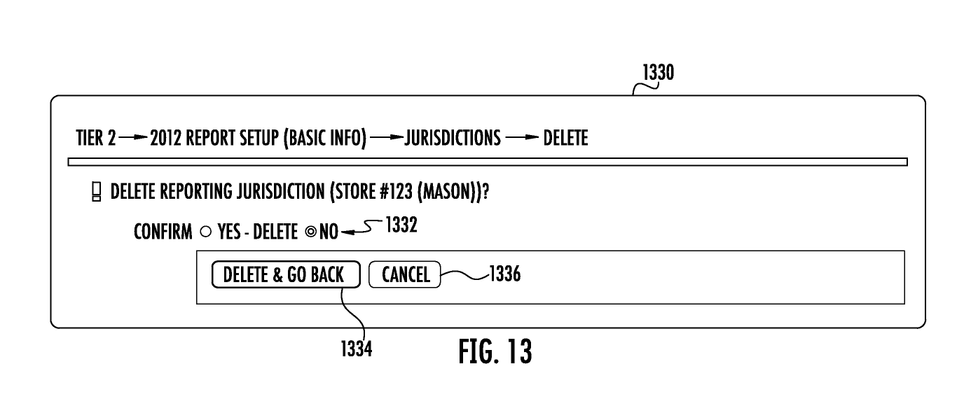

FIG. 13 depicts a user interface 1330 for deleting a reporting jurisdiction for tier-2 spending, according to one or more embodiments shown and described herein. In response to selection of the delete jurisdiction option 1138b from FIG. 11, the user interface 1330 may be provided. As illustrated, the user interface 1330 includes a confirm field 1332, a delete option 1334, and a cancel option 1336. If the user wishes to delete a jurisdiction and selects the delete jurisdiction option 1138b from FIG. 11, the user may then confirm the deletion by selecting the appropriate radio option on the confirm field 1332 and selecting the delete option 1334. If the user wishes to cancel this action, the user may select the cancel option 1336.

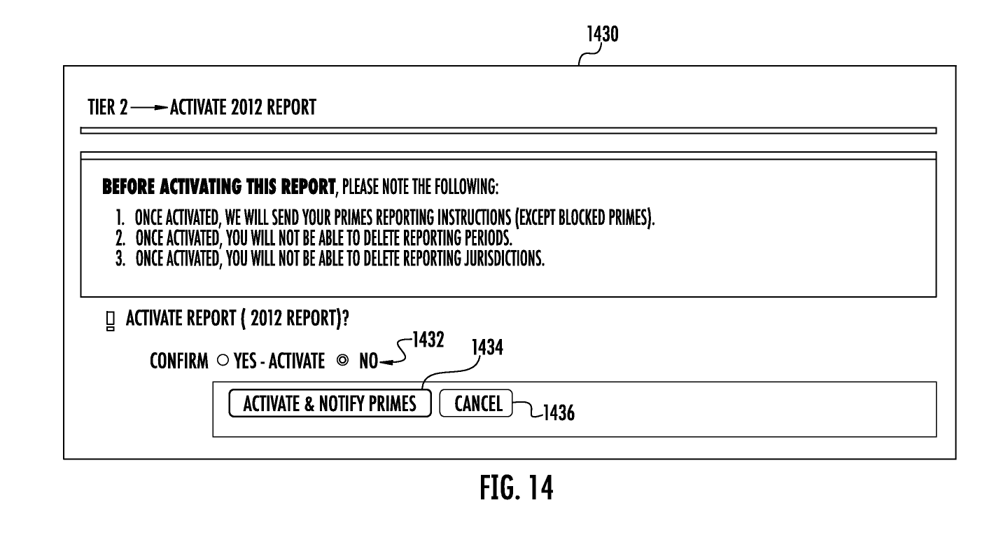

FIG. 14 depicts a user interface 1430 for activating a report for prime suppliers of tier-2 spending, according to one or more embodiments shown and described herein. In response to creating the report, as well as creating the reporting period and/or jurisdiction, the user may activate the report via the user interface 1430, thereby creating a report request for a prime to create a report. As illustrated, the user interface 1430 includes a confirm field 1432, an activate option 1434, and a cancel option 1436. In response to selection of the appropriate radio option in the confirm field 1432 and selection of the activate option 1434, the report may be created for automatic generation (according to the reporting period). If the user does not wish to create the report, the user may select the cancel option 1436.

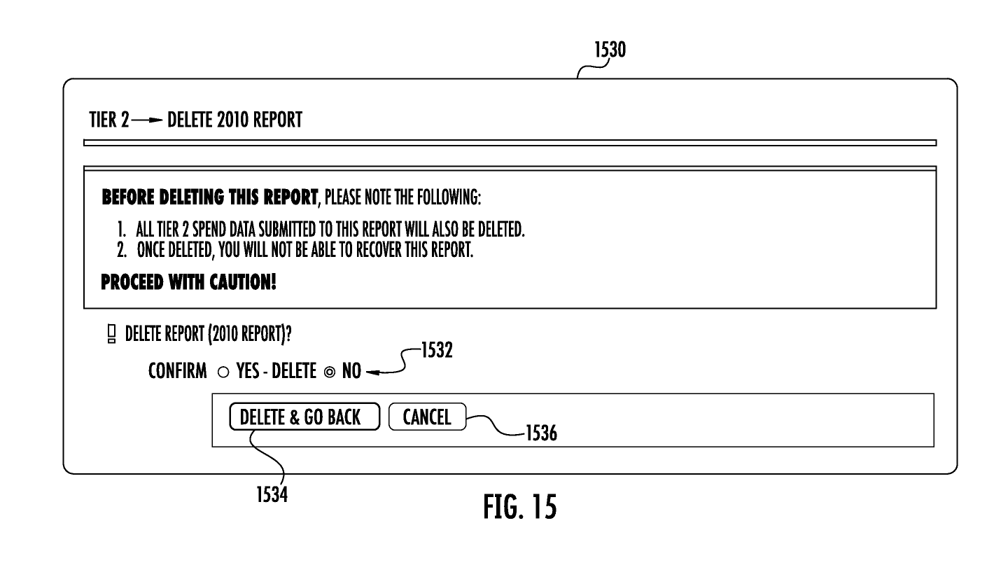

FIG. 15 depicts a user interface 1530 for deleting a report, according to one or more embodiments shown and described herein. In response to selection of the delete report option 338d from FIG. 3, the user interface 1530 may be provided. As illustrated, the user interface 1530 includes a confirm field 1532, a delete option 1534, and a cancel option 1536. If the user wishes to delete a report and selects the delete report option 338d from FIG. 3, the user may then select the appropriate option in the confirm field 1532 and then select the delete option 1534. If the user wishes to cancel this operation, the user may select the cancel option 1536.

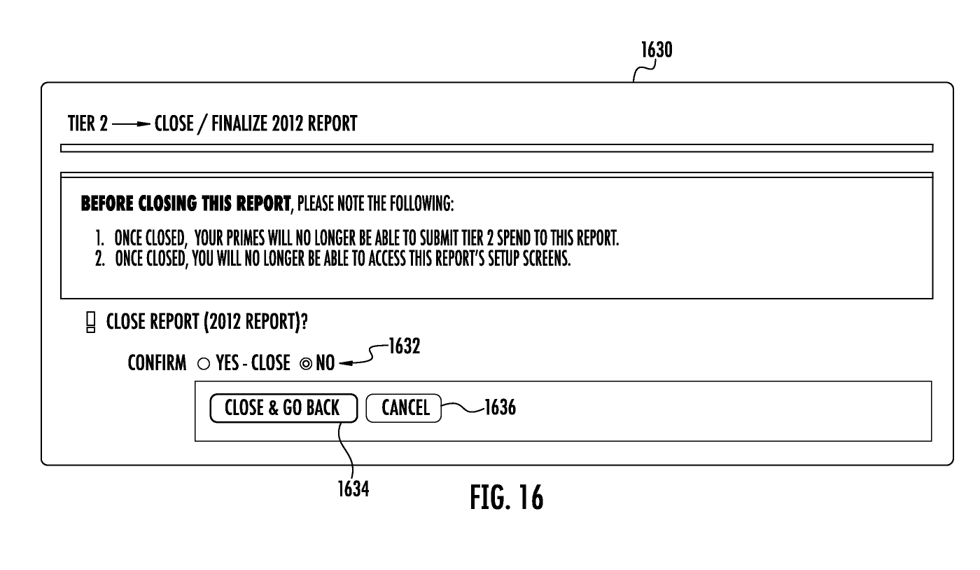

FIG. 16 depicts a user interface 1630 for finalizing a report, according to one or more embodiments shown and described herein. In response to selection of the close report option 338c from FIG. 3, the user interface 1630 may be provided. As illustrated, the user interface 1630 includes a confirm field 1632, a close option 1634, and a cancel option 1636. If the user wishes to close a report and selects the corresponding close report option 338c from FIG. 3, the user may then select the appropriate radio option from the confirm field 1632 and the close option 1634.

It should be understood that closing a report may be different than deleting a report in one or more ways. Specifically, if a user wishes to delete all data submitted to the report, the user should select delete report option 338d from FIG. 3 and should proceed as described with reference to FIG. 15. If the user only wishes to close the report such that a prime may no longer submit data, but maintain the data that is has already been received, the user may select the close report option 338c and may proceed as described as described with reference to FIG. 16.

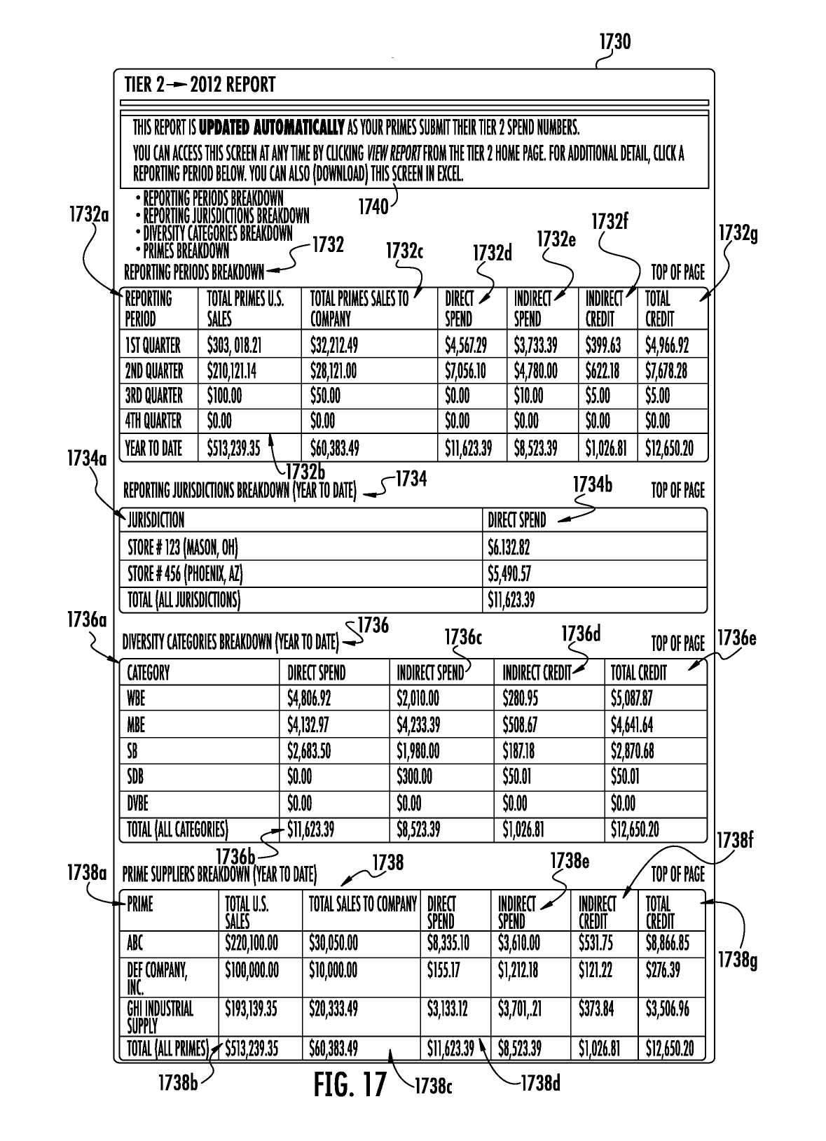

FIG. 17 depicts a user interface 1730 for providing a tier-2 report, according to one or more embodiments shown and described herein. In response to selection of the view report option 338a from FIG. 3, the user interface 1730 may be provided. As illustrated, the user interface 1730 includes a reporting period breakdown area 1732, a reporting jurisdiction breakdown area 1734, a diversity categories breakdown area 1736, and a prime supplier breakdown area 1738. The reporting period breakdown area 1732 provides information related to the designated (and/or default) reporting periods and includes a reporting period field 1732a, a total prime sales field 1732b, a total prime sales to a particular customer field 1732c, a direct spend field 1732d, an indirect spend field 1732e, an indirect credit field 1732f, and a total credit field 1732g. As will be understood, the total prime sales field 1732b provides tier-2 sales statistics of all primes in the United States, while the total prime sales to a particular customer field 1732c provides information regarding sales figures for a particular customer (in this example, the user's company). The direct spend field 1732d relates to all direct sales for tier-2 customers, while the indirect spend field 1732e relates to sales data indirectly related to tier-2 customers. Similarly, the indirect credit field 1732f identifies the amount credited indirectly for tier-2 customers. As an example, if a company spends $100 for the inputs to produce a unit, and 20 percent of all input costs were spent with diverse suppliers, then $20 of that unit cost counts as direct diverse spend for the company and as indirect spend for the customers of that company. The total credit field 1732g provides data related to the total credits provided during each of the reporting periods.

Similarly, the reporting jurisdiction breakdown area 1734 includes a jurisdiction field 1734a and a direct spend field 1734b. The jurisdiction field 1734a may provide the default and/or user selected jurisdictions, as described above. The direct spend field 1734b provides the tier-2 spending for each of the depicted jurisdictions.

The diversity categories breakdown area 1736 includes a category field 1736a, a direct spend field 1736b, and indirect spend field 1736c, and indirect credit field 1736d, and a total credit field 1736e. As an example, diversity categories include women's business enterprise (WBE), minority business enterprise (MBE), small business (SB), small disadvantaged business (SDB), disabled veteran business enterprise (DVBE), etc. As illustrated, the direct spend field 1736b identifies direct spending for each of these diversity categories. The indirect spend field 1736c, the indirect credit field 1736d, and the total credit field 1736e each provide the corresponding information for each of the categories of diverse businesses.

Provided in the prime supplier breakdown area 1738 is information for each of the primes individually. Accordingly, the total sales field 1738b provides total U.S. sales for each of the primes. The total sales to a particular company field 1738c provides total sales numbers for purchases to the particular company (in this example, the user's company). The direct spend field 1738d provides the direct spend for each of the primes. The indirect spend field 1738e provides the amount that was indirectly spent. Similarly, the indirect credit field 1738f provides indirect credits for each of the primes. The total credit field 1738g provides the total credit for each of the primes.

It should be noted that in some embodiments, the user interface 1730 and related data are stored remotely on the remote computing device 104. Accordingly, in these embodiments, a download option 1740 may be provided for the user to download and store at least a portion of the information locally.

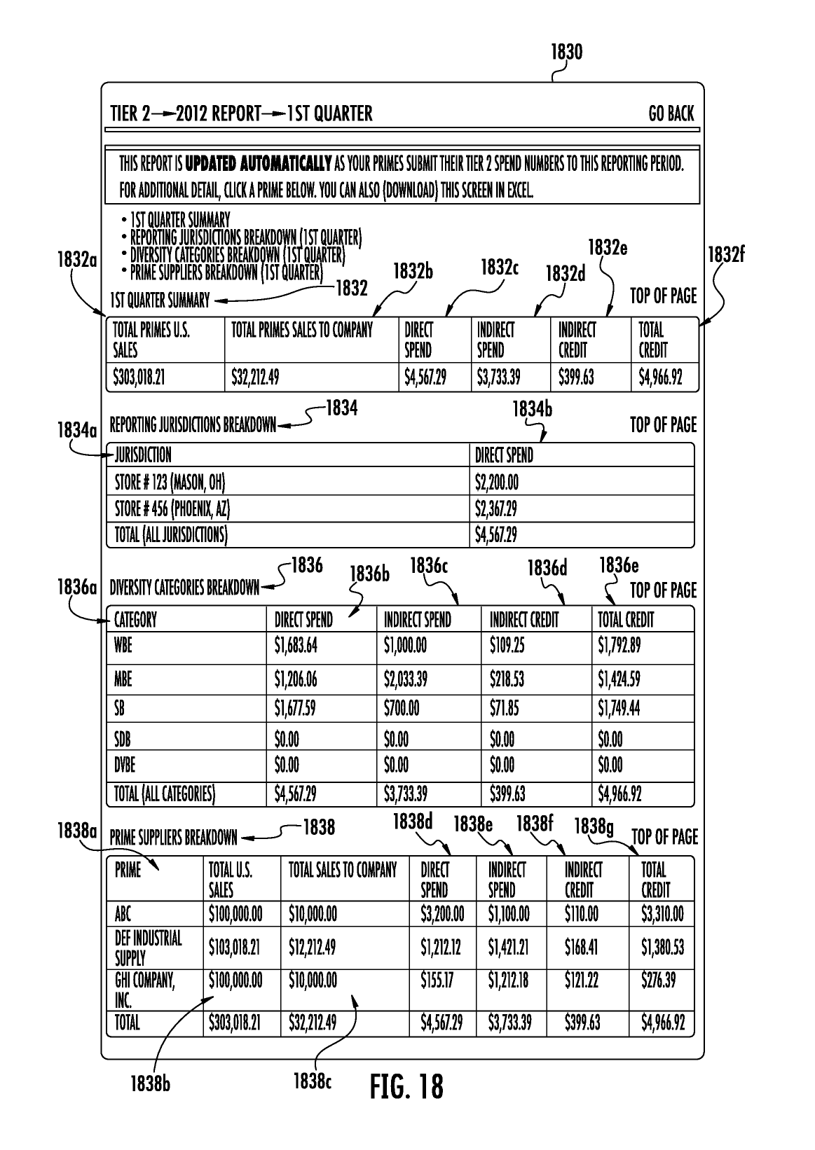

FIG. 18 depicts a user interface 1830 for a first quarter tier-2 report, according to one or more embodiments shown and described herein. In response to selecting one of the periods from the reporting period field 1732a from FIG. 17, the user interface 1830 may be provided. As illustrated, the user interface 1830 includes a 1^{st} quarter summary area 1832, a reporting jurisdiction breakdown area 1834, a diversity categories area 1836, and a prime supplier breakdown area 1838. The 1^{st} quarter summary area 1832 includes a total prime sales field 1832a, which provides financial information related to all prime sales for the selected period. The total prime sales to a particular company field 1832b provides financial information between all primes and a predetermined company (in this embodiment, the user's company). The direct spend field 1832c identifies an amount that was directly spent by primes for the selected period. The indirect spend field 1832d provides an amount that was indirectly spent for the period. The indirect credit field 1832e provides information related to indirect credit information. The total credit field 1832f provides an amount of total credit for the primes during the period.

Similarly, the reporting jurisdiction breakdown area 1834 provides a jurisdiction field 1834a, which includes default and/or user-defined jurisdictions. The direct spend field 1834b provides an amount spent for each of the jurisdictions provided during the selected period.

The diversity categories area 1836 provides a diversity category field 1836a for providing one or more diversity categories, as described above. The direct spend field 1836b provides financial information related to the direct spending for each of the categories of diversity businesses during the selected period. The indirect spend field 1836c provides indirect spending for each of the types of businesses provided during the selected period. The indirect credit field 1836d provides a total credit of the business category for the selected period.

The prime supplier breakdown area 1838 includes a prime field 1838a for listing a plurality of primes. The total sales field 1838b provides the sales of each of the primes for the selected period. The total sales to a particular company field 1838c provides financial data related to sales to a predetermined company (in this embodiment, the user's company). The direct spend field 1838d provides direct spending financial data for each of the primes during the selected period. The indirect spend field 1838e provides indirect spending data. The indirect credit field 1838f provides indirect credit data. The total credit field 1838g provides a total credit for each of the primes during the selected period.

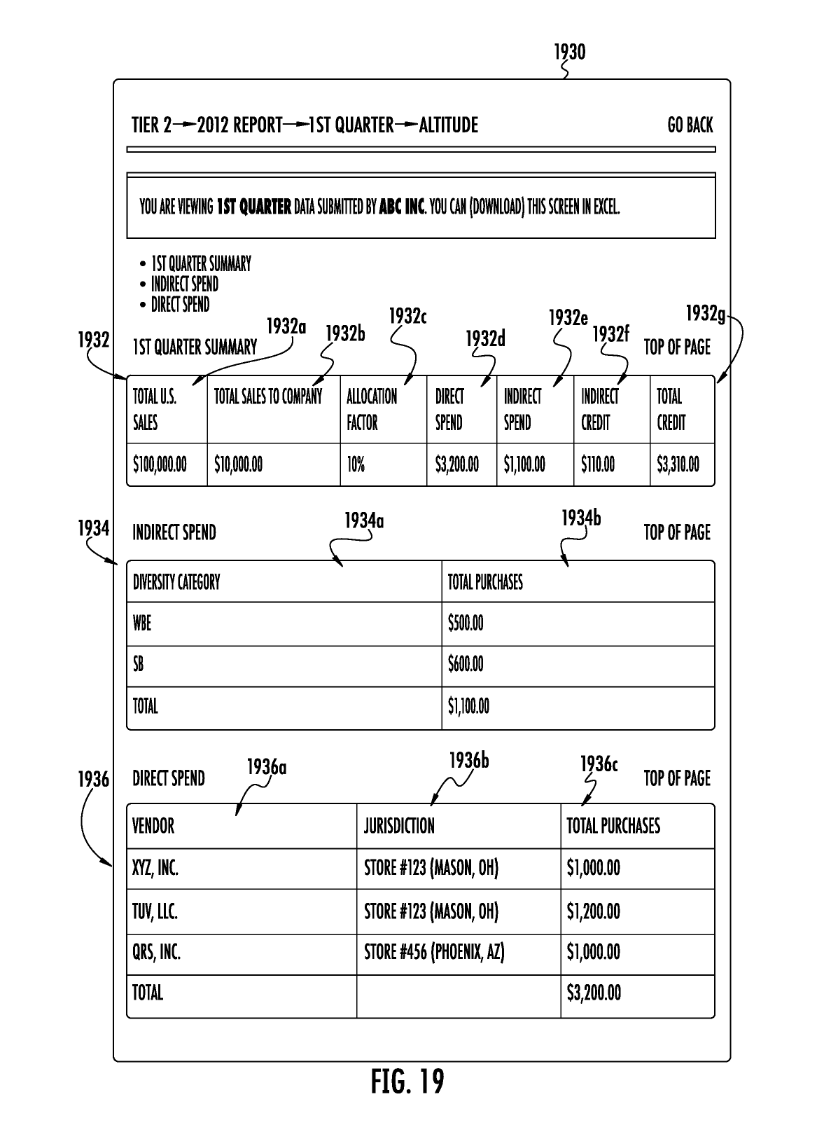

FIG. 19 depicts user interface 1930 for providing a first quarter summary report of direct spending and indirect spending, according to one or more embodiments shown and described herein. In response to selection of one of the primes from the prime field 1838a of FIG. 18, the user interface 1930 may be provided. As illustrated, the user interface 1930 includes a 1^{st} quarter summary section 1932, an indirect spend area 1934, and a direct spend area 1936 for a selected prime. In the 1^{st} quarter summary section 1932, a total sales field 1932a is provided for the particular prime and during the selected period. In the total sales to a particular company field 1932b, the sales data for a prime during the selected period to the predetermined company is provided. The allocation factor field 1932c indicates a percentage of sales this prime had versus all other primes for this company and during this period. The direct spend field 1932d provides direct spend data. The indirect spend field 1932e provides indirect spend data during the selected period. As discussed above, the indirect credit field 1932f and the total credit field 1932g provide the indirect and total credit data respectively, for this particular prime and during the selected period.

In the indirect spend area 1934, a diversity category field 1934a is provided to show which categories of suppliers were used by this prime in the indirect sales. The total purchases field 1934b provides the financial data associated with these diversity categories.

In the direct spend area 1936, a vendor field 1936a is provided that identifies various vendors for the prime during the selected period. The jurisdiction field 1936b identifies the jurisdiction associated with those vendors. The total purchases field 1936c identifies a value of the purchases that were made by with the vendors during the selected period.

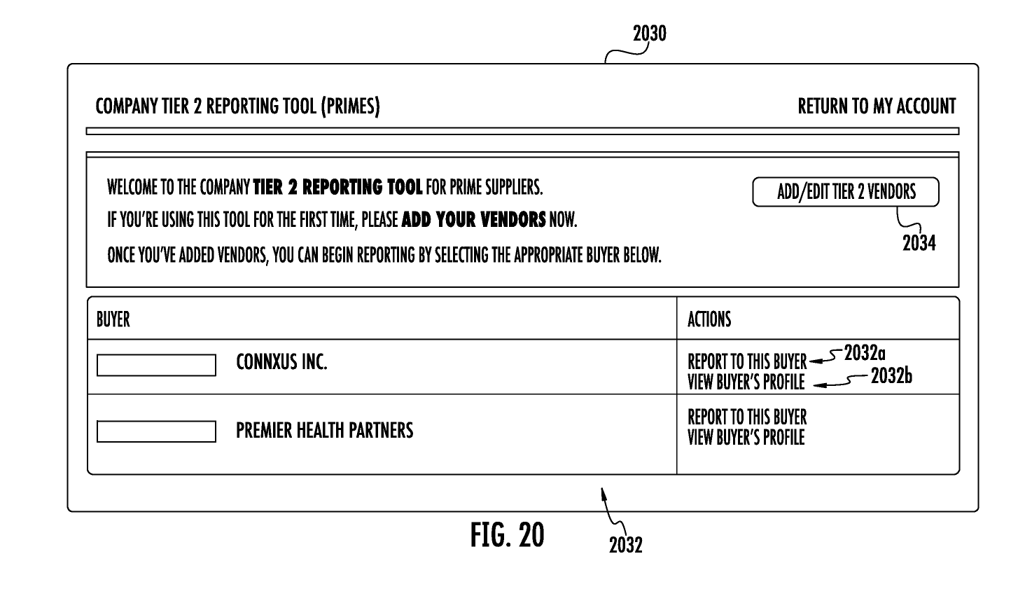

FIG. 20 depicts a user interface 2030 for a prime to add tier-2 suppliers to the prime account, according to one or more embodiments shown and described herein. In response to a user selection of the send invitations option 534 from FIG. 5, a potential prime may be sent an indication to create an account and thereby provide a data request for reporting tier-2 diversity data. Accordingly, the prime may create the account and may identify vendors that the prime uses via the user interface 2030. As illustrated, the user interface 2030 of FIG. 20 includes a buyer listing area 2032 and an add/edit tier-2 vendors option 2034. The buyer listing area 2032 may include a listing of all buyers that are associated with this prime. Included within the buyer listing area 2032 are a report option 2032a and a view profile option 2032b. In response to selection of the report option 2032a, the prime may report their tier-2 spending to that particular buyer. In response to selection of the view profile option 2032b, profile for the selected buyer may be provided.

Also included in the user interface 2030 is the add/edit tier-2 vendors option 2034. In response to selection of the add/edit tier-2 vendors option, additional options for adding and/or editing vendors for this prime may be provided, as described in more detail below.

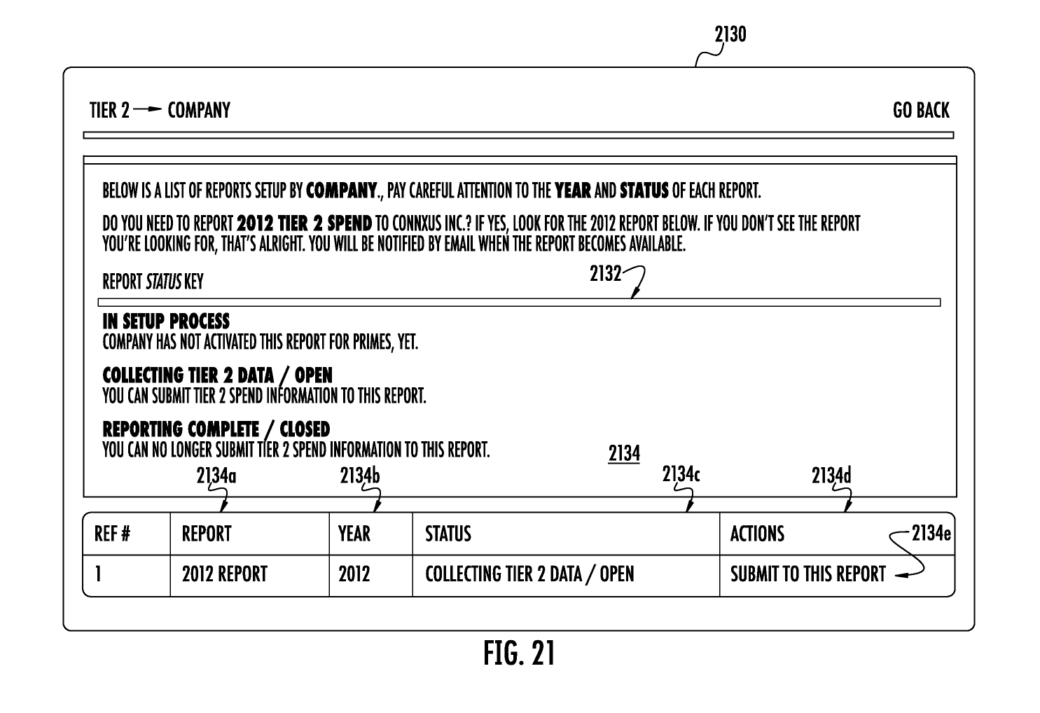

FIG. 21 depicts a user interface 2130 for providing a prime with a list of reports setup by a buyer of the prime, according to one or more embodiments shown and described herein. In response to selection of the view profile option 2032b, the user interface 2130 may be provided. As illustrated, the user interface 2130 includes a report status key 2132, as well as a status chart area 2134. The report status key 2132 provides a description related to information in the status chart area 2134. The status chart area 2134 includes a reference number field, a report name field 2134a, a year field 2134b, a status field 2134c, and an actions field 2134d, and a submit option 2134e. The report name field 2134a provides a designated name for each of the reports. The year field 2134b provides the year (or other period) that the report addresses. The status field 2134c provides the current status report, as outlined in the report status key 2132. The actions field 2134d provides the available actions for the prime to select for a report. In response to selection of the submit option 2134e, the report may be submitted to the remote computing device 104 for providing to one or more predetermined companies.

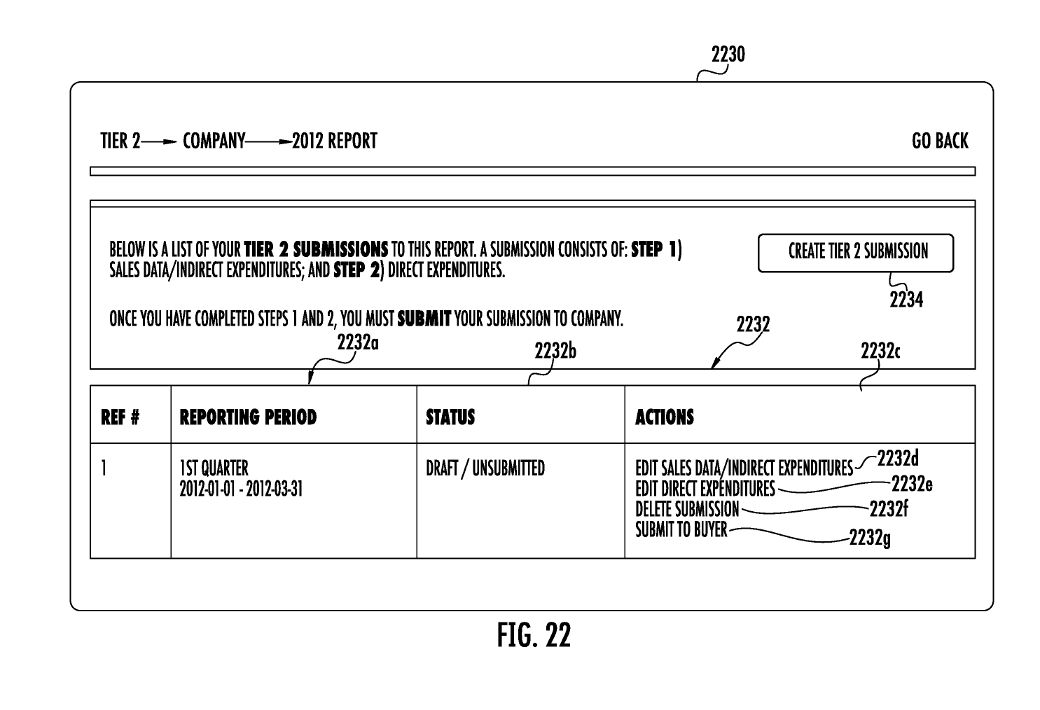

FIG. 22 depicts a user interface 2230 for providing a tier-2 submission for a report, according to one or more embodiments shown and described herein. In response to selecting a report from the report name field 2134a in FIG. 21, the user interface 2230 may be provided. As illustrated, the user interface 2230 includes report area 2232 and a create submission option 2234. Specifically, the report area 2232 includes a reporting period field 2232a, a status field 2232b, and an actions field 2232c. The reporting period field 2232a provides submissions for user-defined (and/or default) periods. The status field 2232b provides the current status of the submission. The actions field 2232c provides options for the submission. As an example, the actions field 2232c includes an edit indirect option 2232d, an edit direct option 2232e, a delete option 2232f, and a submit option 2232g. In response to selection of the edit indirect option 2232d, options for editing the indirect expenditures and/or sales data may be provided. In response to selection of the edit direct option 2232e, options for editing the direct expenditures may be provided. In response to selection of the delete option 2232f, the corresponding submission may be deleted. In response to selection of the submit option 2232g, the submission may be submitted to the buyer. Similarly, in response to selection of the create submission option 2234 a new submission for the report may be created.

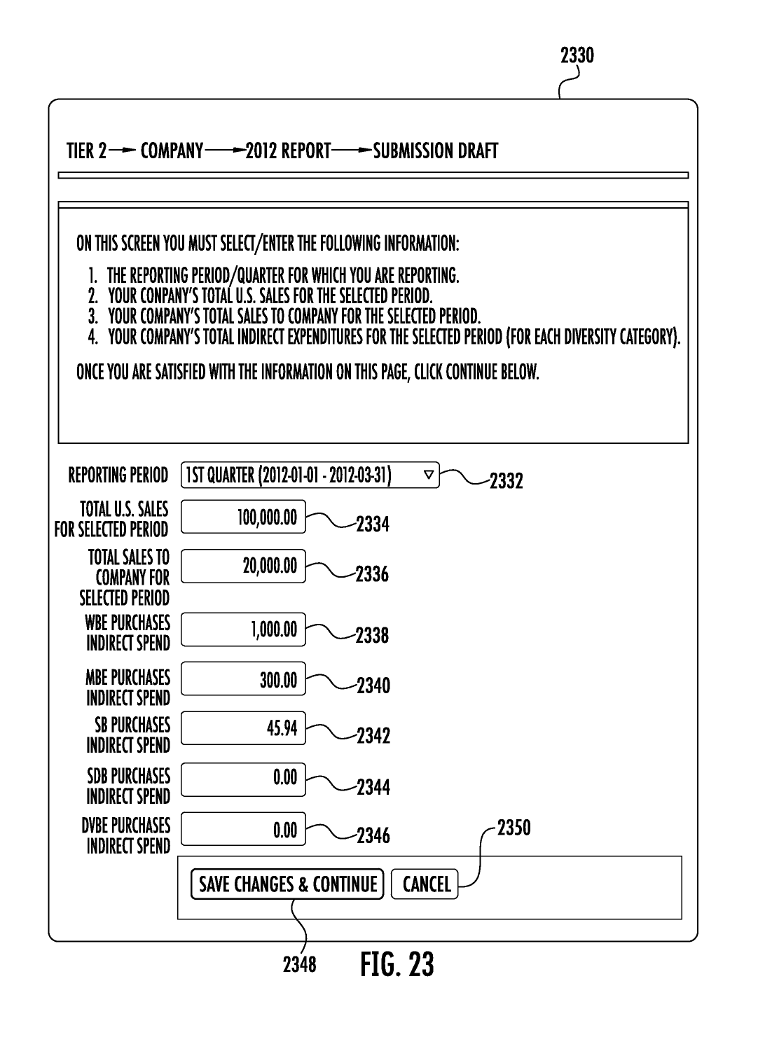

FIG. 23 depicts a user interface 2330 for a prime to submit a draft report of tier-2 diversity spending, according to one or more embodiments shown and described herein. In response to selection of the create submission option 2234, the user interface 2330 may be provided. As illustrated, the user interface 2330 includes a reporting period field 2332, a total sales field 2334, a total sales to buyer field 2336, a WBE purchases field 2338, a MBE purchases field 2340, an SB purchases field 2342, an SDB purchases field 2344, a DVBE purchases field 2346, a save option 2348, and a cancel option 2350. In the reporting period field 2332, the prime may manually select the desired reporting period for this submission. In the total sales field 2334, the prime may enter the total U.S. sales for the selected period. In the total sales to buyer field 2336, the prime may enter the total sales made during the period for the particular company. In the WBE purchases field 2338, the prime may enter the indirect spend with WBEs during the selected period. In the MBE purchases field 2340, the prime may enter the indirect spend with MBEs during the selected period. In the SB purchases field 2342, the prime may enter the indirect spend with SBs during the selected period. In the SDB purchases field 2344, the prime may enter the indirect spend with SDBs during the selected period. In the DVBE purchases field 2346, the prime may enter the indirect spend with DVBEs during the selected period. Once the prime has entered the desired information, selection of the save option 2348 will save the submission draft. Selection of the cancel option 2350 cancels the actions performed in the user interface 2330.

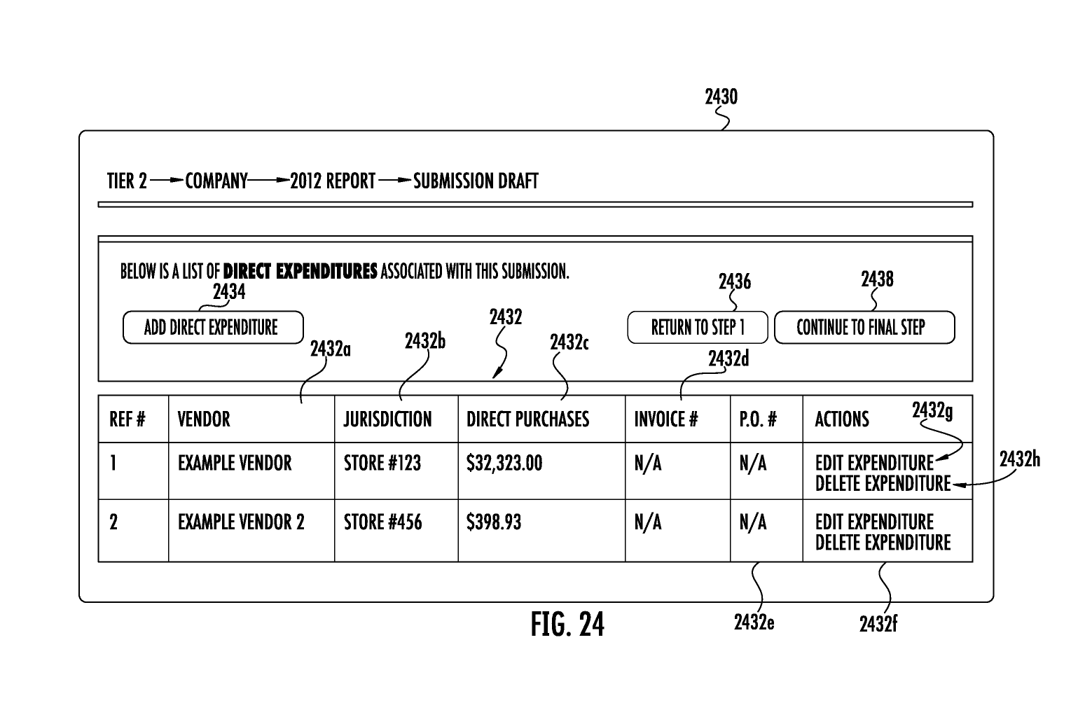

FIG. 24 depicts a user interface 2430 for viewing and editing direct expenditures by a prime, according to one or more embodiments shown and described herein. In response to selection of the edit direct option 2232e, the user interface 2430 may be provided. As illustrated, the user interface 2430 includes a direct expenditure area 2432, an add option 2434, a return option 2436, and a continue option 2438. The direct expenditure area 2432 includes a vendor field 2432a, a jurisdiction field 2432b, a direct purchases field 2432c, an invoice field 2432d, a purchase order field 2432e, and an actions field 2432f. The vendor field 2432a includes one or more vendors with which the prime had a direct expenditure. The jurisdiction field 2432b includes a jurisdiction for the provided vendors. The direct purchases field 2432c provides a value of the direct purchases made with the vendors. The invoice field 2432d and the purchase order field 2432e provide an invoice number and a purchase number, respectively. The actions field 2432f provides options that may be performed for the expenditure. As an example, the actions field 2432f may include an edit expenditure option 2432g and a delete option 2432h.

Also included in the user interface 2430 are the add option 2434, the return option 2436 and the continue option 2438. In response to selection of the add option 2434, an expenditure may be added to the report. In response to selection of the return option 2436, the prime may be returned to a previous user interface. In response to selection of the continue option 2438, the prime may proceed to another user interface.

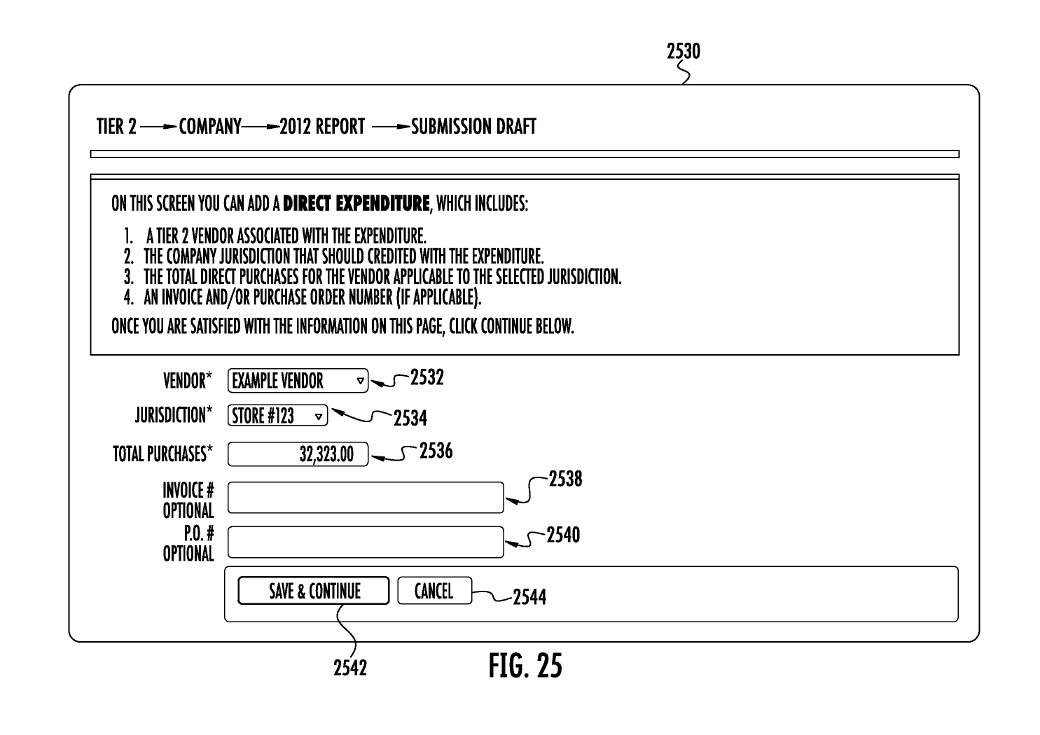

FIG. 25 depicts a user interface 2530 for a prime to add a direct expenditure, according to one or more embodiments shown and described herein. In response to selection of the add option 2434 from FIG. 24, the user interface 2530 may be provided. As illustrated, the user interface 2530 includes a vendor field 2532, a jurisdiction field 2534, a total purchases field 2536, an invoice number field 2538, a purchase order number field 2540, a save option 2542, and a cancel option 2544. In the vendor field 2532, the prime may select a vendor for this expenditure. In the jurisdiction field 2534, the prime may select a jurisdiction associated with this expenditure. In the total purchases field 2536, the prime may enter the value of purchases made from this vendor. In the invoice number field 2538 and the purchase order number field 2540, the prime may enter the invoice number and the purchase number, respectively. In response to selection of the save option 2542, the information may be saved. In response to selection of the cancel option 2544, the direct expenditure submission may be canceled.

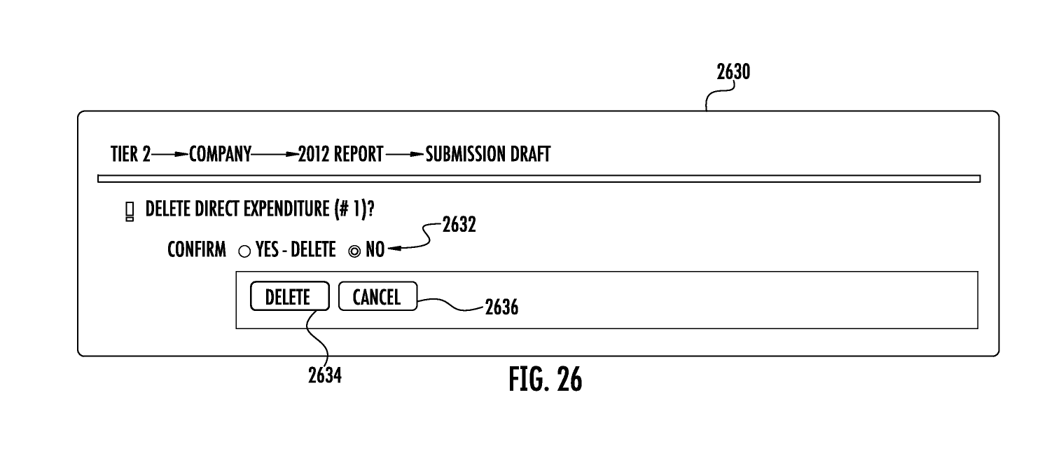

FIG. 26 depicts a user interface 2630 for a prime to delete a direct expenditure, according to one or more embodiments shown and described herein. In response to selection of the delete option 2432h, the user interface 2630 may be provided. As illustrated, the user interface 2630 includes a confirm field 2632, a delete option 2634, and a cancel option 2636. If the prime desires to delete a submission, the user may select the appropriate radio option in the confirm field 2632 and then select the delete option 2634. If the prime wishes to cancel this deletion, he/she may select the cancel option 2636.

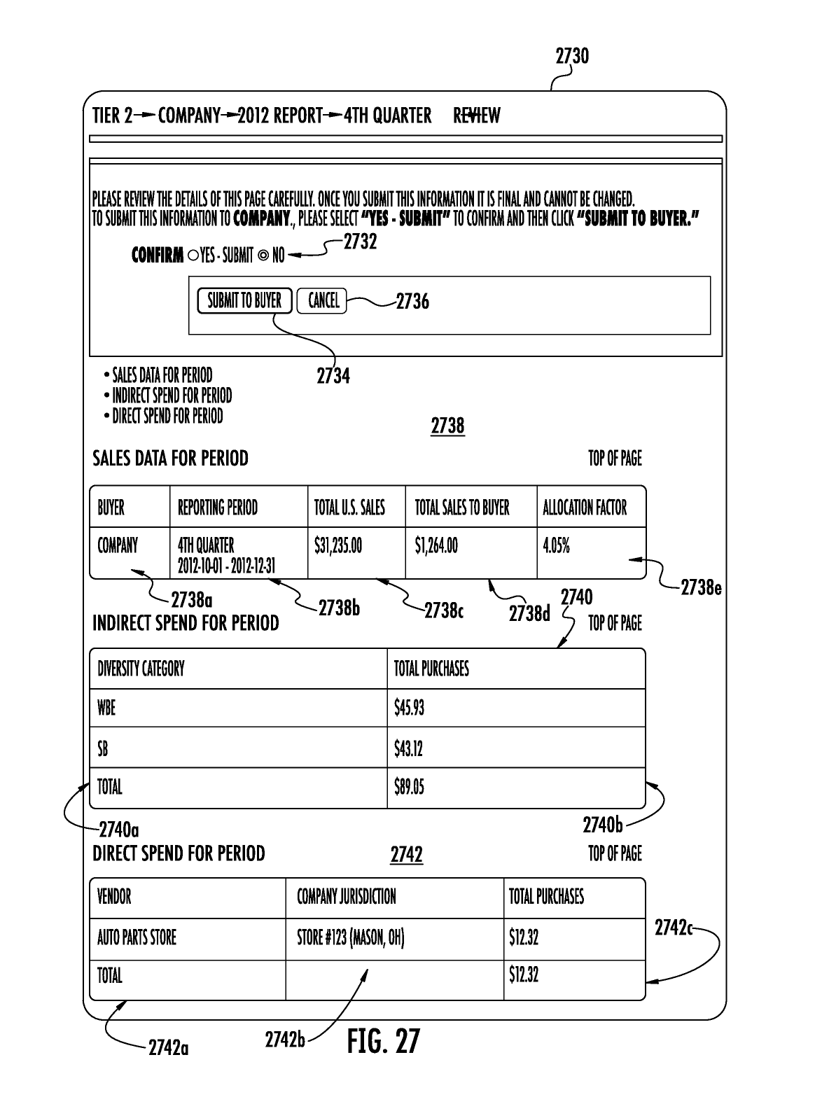

FIG. 27 depicts a user interface 2730 for a prime to view and submit a report to a buyer, according to one or more embodiments shown and described herein. In response to selection of the submit option 2232g from FIG. 22, the user interface 2730 may be provided. As illustrated, the user interface 2730 includes a confirm field 2732, a submit option 2734, a cancel option 2736, a sales data area 2738, an indirect spend area 2740, and a direct spend area 2742. If the prime wishes to submit the report to the buyer, the prime may select the appropriate radio option in the confirm field 2732 and select the submit option 2734. If the user wishes to cancel submission, he/she may select the cancel option 2736.

Additionally, the sales data area 2738 includes a buyer field 2738a, a reporting period field 2738b, a total sales field 2738c, a total sales to buyer field 2738d, and an allocation factor field 2738e. The indirect spend area 2740 includes a diversity category field 2740a and a total purchases field 2740b that indicates purchases for each category of business. The direct spend area 2742 includes a vendor field 2742a, a jurisdiction field 2742b, and a total purchases field 2742c.

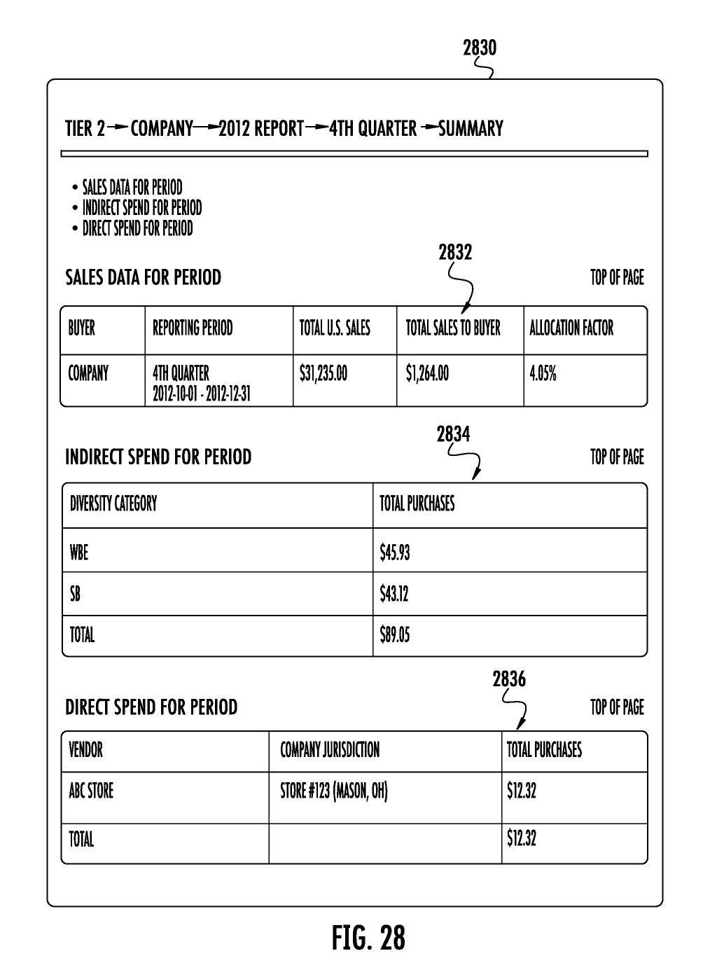

FIG. 28 depicts a user interface 2830 for a prime to view a quarterly summary report for a buyer, according to one or more embodiments shown and described herein. In response to selection of the submit option 2734 from FIG. 27, the user interface 2830 may be provided. As illustrated, the user interface 2830 includes a sales data area 2832, an indirect spend area 2834, and a direct spend area 2836. These areas correspond to the similarly labeled areas in FIG. 27 and confirm the data that was submitted.

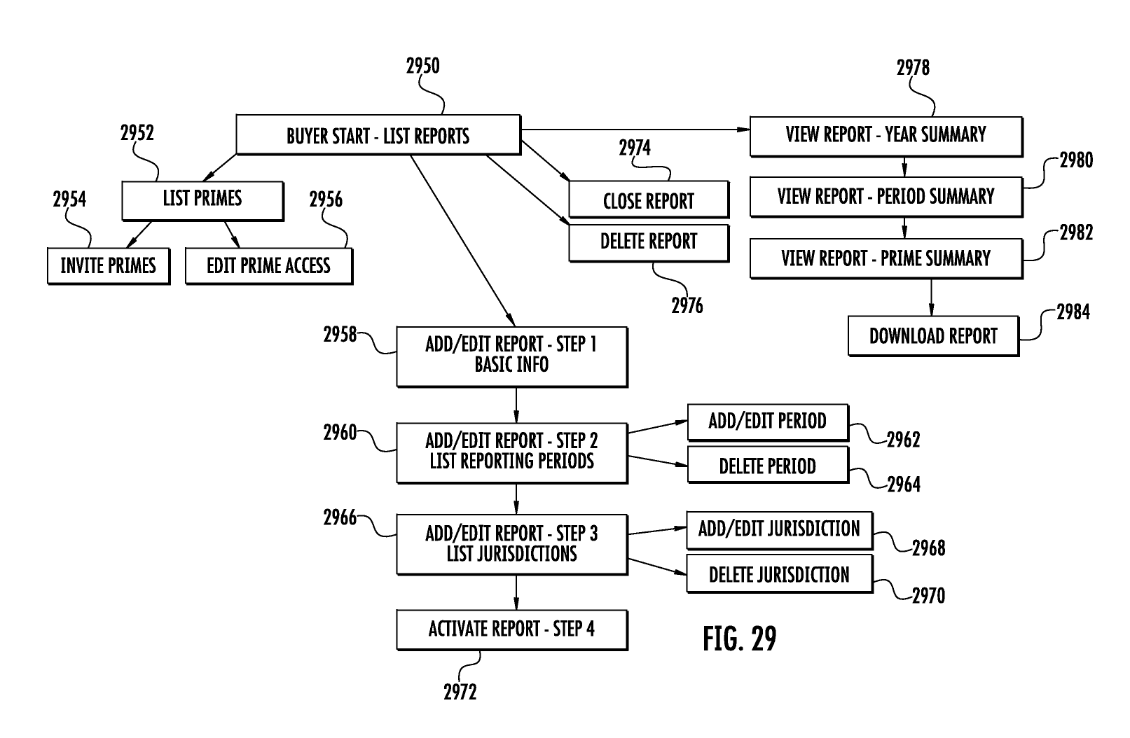

FIG. 29 depicts a flowchart for a buyer to create and view reports of tier-2 spending, according to one or more embodiments shown and described herein. As illustrated, the flowchart includes actions for inviting primes, creating reports, viewing reports, as well as adding and editing other information. Specifically, in block 2950 the buyer may begin. Along a first branch, the buyer may list primes to which he/she wants tier-2 reporting in block 2952. Options for inviting primes may be provided in block 2954 and options for editing prime access may be provided in block 2956.

Along a second branch, reports may be added and/or edited with basic info in block 2958. In block 2960, reports may be added and/or edited by listed reporting periods. In block 2962 the period may be added or edited. In block 2964, the selected period may be deleted. Additionally, in block 2966, jurisdictions may be added and/or edited. In block 2968 the options for adding and/or editing the jurisdiction may be provided, while in block 2970, the jurisdiction may be deleted. In block 2972, the report may be activated.

In a third and fourth branch, a report may be closed in block 2974 and a report may be deleted in block 2976. In a fifth branch, a year summary report may be viewed in block 2978. In block 2980, a period summary report may be provided. In block 2982 a prime summary report may be viewed. In block 2984, one or more of the reports can be downloaded.

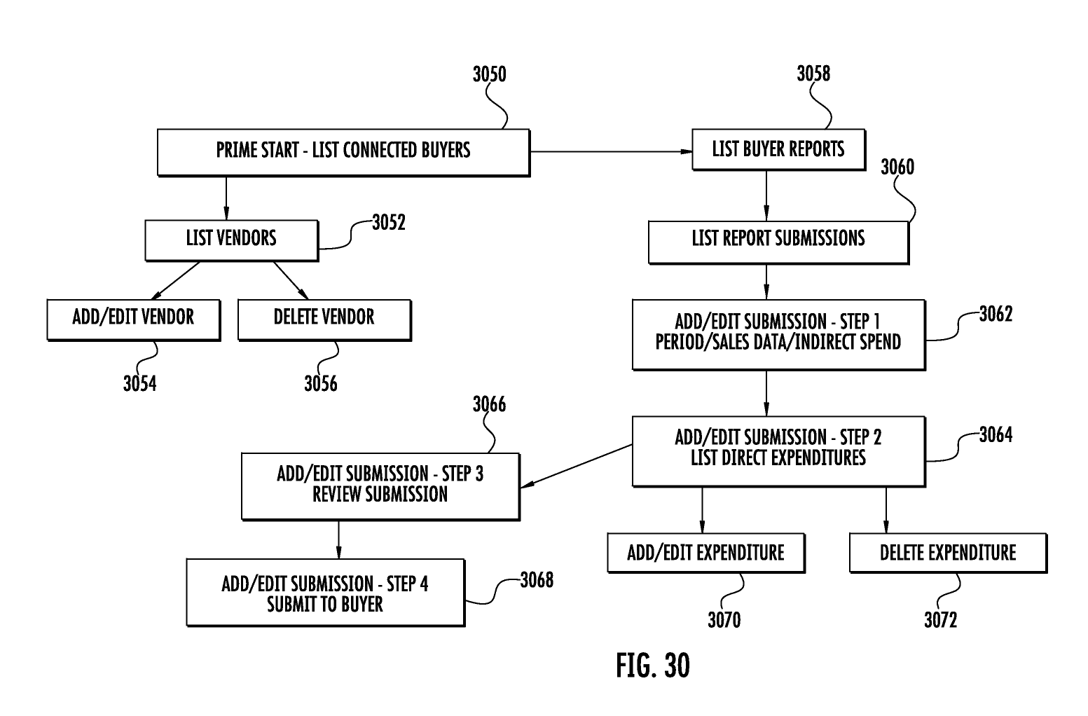

FIG. 30 depicts a flowchart for a prime to provide expenditures for tier-2 spending, according to one or more embodiments shown and described herein. As illustrated, the flowchart includes actions for including vendors, listing reports, listing expenditures, and providing other information. In block 3050 the prime may start and along a first branch, a list of vendors may be provided in block 3052. The list may be accompanied by options to add and/or edit a vendor in block 3054 and delete a vendor in block 3056.

Along a second branch, buyer reports may be listed in block 3058. In block 3060, a report of submissions may be provided. In block 3062 the submission may be edited with respect to period sales data and/or indirect spend. In block 3064, the submission may be added and/or edited with respect to direct expenditures. Accordingly, in block 3070 the expenditure may be added and/or edited. In block 3072 the expenditure may be deleted.

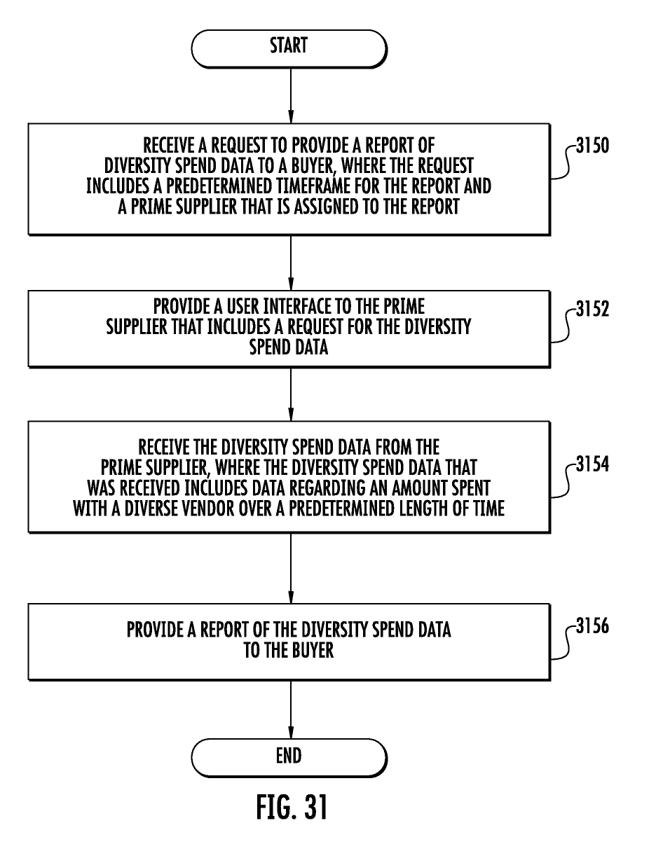

FIG. 31 depicts a flowchart for providing diversity data, according to embodiments disclosed herein. As illustrated in block 3150, a request may be received to provide a report of diversity spend data to a buyer, where the request includes a predetermined timeframe for the report and a prime supplier that is assigned to the report. In block 3152, a user interface may be provided to the prime supplier that includes a request for the diversity spend data. In block 3154, the diversity spend data may be received from the prime supplier, where the diversity spend data that was received includes data regarding an amount spent with a diverse vendor over a predetermined length of time. In block 3156, a report of the diversity spend data may be provided to the buyer.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A diversity reporting tool comprising:
a memory component that stores logic that, when executed by a computing device, performs at least the following:
receive a report request to provide a report of diversity spend data to a buyer, wherein the report request includes a predetermined timeframe for the report and a prime supplier that is assigned to the report;
provide a user interface to the prime supplier that includes a data request for the diversity spend data;
receive the diversity spend data from the prime supplier, wherein the diversity spend data that was received includes data regarding an amount spent with a diverse vendor over a predetermined length of time; and
provide a report of the diversity spend data to the buyer.

2. The diversity reporting tool of claim 1, wherein the diversity spend data includes at least one of the following: total prime sales amount, a total sales amount to the buyer, a direct spend amount, an indirect spend amount, an indirect credit amount, and a total credit amount.

3. The diversity reporting tool of claim 1, wherein the diversity spend data includes at least one of the following: a jurisdiction and a diversity category.

4. The diversity reporting tool of claim 1, wherein the diversity spend data includes a diversity category and wherein the diversity category includes at least one of the following: a women's business enterprise (WBE), a minority business enterprise (MBE), a small business (SB), a small disadvantaged business (SDB), and a disabled veteran business enterprise (DVBE).

5. The diversity reporting tool of claim 1, wherein the report includes at least one of the following: a reporting periods breakdown, a reporting jurisdictions breakdown, a diversity categories breakdown, and a prime suppliers breakdown.

6. The diversity reporting tool of claim 1, wherein the report includes a reporting periods breakdown that provides at least one of the following for a reporting period: total prime sales, total prime sales to the buyer, direct spend, indirect spend, indirect credit, and total credit.

7. The diversity reporting tool of claim 1, wherein the report includes a diversity categories breakdown that provides at least one of the following for a diversity category: a direct spend, an indirect spend, an indirect credit, and a total credit.

8. A method for diversity reporting comprising:
providing a first user interface to a buyer, wherein the first user interface includes an option to request a report of diversity spend data from a plurality of prime suppliers;
receiving a report request to provide a report of the diversity spend data to the buyer, wherein the report request includes a predetermined timeframe for the report and at least one of the plurality of prime suppliers that is assigned to the report;
providing a second user interface to the at least one prime supplier that includes a data request for the diversity spend data;
receiving the diversity spend data from the at least one prime supplier, wherein the diversity spend data that was received includes data regarding an amount spent with a diverse vendor over a predetermined length of time; and
providing the report of the diversity spend data to the buyer.

9. The method of claim 8, wherein the diversity spend data includes at least one of the following: total prime sales amount, a total sales amount to the buyer, a direct spend amount, an indirect spend amount, an indirect credit amount, and a total credit amount.

10. The method of claim 8, wherein the diversity spend data includes at least one of the following: a jurisdiction and a diversity category.

11. The method of claim 8, wherein the diversity spend data includes a diversity category and wherein the diversity category includes at least one of the following: a women's business enterprise (WBE), a minority business enterprise (MBE), a small business (SB), a small disadvantaged business (SDB), and a disabled veteran business enterprise (DVBE).

12. The method of claim 8, wherein the report includes at least one of the following: a reporting periods breakdown, a reporting jurisdictions breakdown, a diversity categories breakdown, and a prime suppliers breakdown.

13. The method of claim 8, wherein the report includes a reporting periods breakdown that provides at least one of the following for a reporting period: total prime sales, total prime sales to the buyer, direct spend, indirect spend, indirect credit, and total credit.

14. The method of claim 8, wherein the report includes a diversity categories breakdown that provides at least one of the following for a diversity category: a direct spend, an indirect spend, an indirect credit, and a total credit.

15. A system for diversity reporting comprising:
a remote computing device that includes a memory component that stores logic that, when executed by the remote computing device, causes the remote computing device to perform at least the following:
provide a first user interface to a buyer, wherein the first user interface includes an option to request a report of diversity spend data from a plurality of prime suppliers;
receive a report request to provide a report of the diversity spend data to the buyer, wherein the report request includes a predetermined timeframe for the report and at least one of the plurality of prime suppliers that is assigned to the report;
provide a second user interface to the at least one prime supplier that includes a data request for the diversity spend data, wherein the data request includes a reporting period field, a total sales field, and a purchases field, wherein the purchases field includes at least one of the following: a women's business enterprise (WBE), a minority business enterprise (MBE), a small business (SB), a small disadvantaged business (SDB), and a disabled veteran business enterprise (DVBE);
receive the diversity spend data from the at least one prime supplier, wherein the diversity spend data that was received includes data regarding an amount spent with a diverse vendor over a predetermined length of time; and
provide the report of the diversity spend data to the buyer.

16. The system of claim 15, wherein the diversity spend data includes at least one of the following: total prime sales amount, a total sales amount to the buyer, a direct spend amount, an indirect spend amount, an indirect credit amount, and a total credit amount.

17. The system of claim 15, wherein the diversity spend data includes at least one of the following: a jurisdiction and a diversity category.

18. The system of claim 15, wherein the report includes at least one of the following: a reporting periods breakdown, a reporting jurisdictions breakdown, a diversity categories breakdown, and a prime suppliers breakdown.

19. The system of claim 15, wherein the report includes a reporting period breakdown that provides at least one of the following for a reporting period: total prime sales, total prime sales to the buyer, direct spend, indirect spend, indirect credit, and total credit.

20. The system of claim 15, wherein the report includes a diversity categories breakdown that provides at least one of the following for a diversity category: a direct spend, an indirect spend, an indirect credit, and a total credit.
